(19) United States
(12) Patent Application Publication
(10) Pub. No.: US 2006/0218953 A1
(43) Pub. Date: Oct. 5, 2006

(54) Control valve for variable displacement compressor

(75) Inventor: Hisatoshi Hirota, Tokyo (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: TGK CO., LTD., Tokyo (JP)

(21) Appl. No.: 11/389,209

(22) Filed: Mar. 27, 2006

(30) Foreign Application Priority Data
Mar. 31, 2005 (JP) 2005-104409
Nov. 22, 2005 (JP) 2005-337480

(51) Int. Cl. F25B 49/00; F16K 31/02

(52) U.S. Cl. 62/228.5; 251/129.15

(57) ABSTRACT

To enable a control valve for a variable displacement compressor, which operates by sensing a differential pressure between discharge pressure and suction pressure or between the discharge pressure and crankcase pressure, to enhance compression efficiency inside the compressor. In the control valve for a variable displacement compressor, according to the present invention, after a valve element on a high pressure side closes a valve hole, a valve element on a low pressure side opens a valve hole. Therefore, it is possible to eliminate a region in which both the valves on the high pressure side and the low pressure side are simultaneously open. This makes it possible to prevent refrigerant introduced into a crankcase from being immediately delivered, which makes it possible to obtain a sufficient compression efficient.

### CROSS-REFERENCE TO RELATED APPLICATIONS

This application claims priority of Japanese Applications No. 2005-104409 filed on Mar. 31, 2005 and entitled “control valve for variable displacement compressor”, and No. 2005-337480 filed on Nov. 22, 2005 and entitled “control valve for variable displacement compressor”.

### BACKGROUND OF THE INVENTION

1) Field of the Invention

The present invention relates to a control valve for a variable displacement compressor, and more particularly to a control valve for a variable displacement compressor, for controlling the displacement of the compressor as a component of a refrigeration cycle of an automotive air conditioner.

2) Description of the Related Art

A compressor used in the refrigeration cycle of an automotive air conditioner, for compressing refrigerant, uses an engine as a drive source, and hence is incapable of performing rotational speed control. To eliminate the inconvenience, a variable displacement compressor capable of varying the compression capacity of refrigerant is employed so as to obtain an adequate cooling capacity without being constrained by the rotational speed of the engine.

In such a variable displacement compressor, a wobble plate fitted on a shaft driven by the engine for rotation has compression pistons connected thereto, and by varying the inclination angle of the wobble plate, the stroke of the pistons is varied to vary the discharge amount of refrigerant.

The inclination angle of the wobble plate is continuously changed by introducing part of compressed refrigerant into a hermetically closed crankcase, and causing a change in the pressure of the introduced refrigerant, thereby changing the balance of pressures acting on the both sides of each piston.

The pressure in the crankcase is adjusted by providing a control valve between a discharge chamber and a crankcase of the compressor, or between the crankcase and a suction chamber of the compressor, and changing the flow rate of refrigerant introduced from the discharge chamber into the crankcase, or changing the flow rate of refrigerant delivered from the crankcase to the suction chamber. For example, in the former case, an orifice is provided between the crankcase and the suction chamber, to form a path through which refrigerant flows from the discharge chamber to the suction chamber. The control valve includes a valve element which can be fitted to and removed from a valve hole as a part of a refrigerant passage communicating between the discharge chamber and the crankcase to close and open the valve hole. Then, the amount of lift of the valve element from the valve hole is controlled by driving a solenoid, whereby the flow rate of refrigerant flowing from the discharge chamber side to the suction chamber side (see e.g. Japanese Unexamined Patent Publication (Kokai) No. 2003-328936 (e.g. FIG. 2)).

More specifically, the control valve has a valve element that is axially movably supported within a body and forms a component of a three-way valve. This valve element has a high-pressure valve element and a low-pressure valve element formed integrally therewith at opposite ends thereof, whereby the high-pressure valve element opens and closes a first valve hole communicating between the discharge chamber and the crankcase and the low-pressure chamber opens and closes a second valve hole communicating between the crankcase and the suction chamber. Toward the second valve hole associated with this valve element, a first shaft and a second shaft are sequentially arranged in a coaxial manner. The solenoid axially drives the second shaft, which in turn transmits the driving force to the valve element via the first shaft.

In other words, this valve element not only receives discharge pressure (Pd) from the upstream side of the high-pressure valve element, but also receives suction pressure (Ps) at the downstream side of the low-pressure valve element. In this case, the downstream side of the high-pressure valve element receives crankcase pressure (Pc1) introduced into the crankcase, and the upstream side of the low-pressure valve element receives crankcase pressure (Pc2=Pc1) delivered from the crankcase. However, the diameter of the first valve hole and that of the second valve hole are equal to each other, so that the two crankcase pressures applied to the valve element are cancelled out. As a result, the control valve senses only the differential pressure (Pd−Ps) between the discharge pressure (Pd) and the suction pressure (Ps), and opens and closes the valve holes such that the differential pressure is maintained at a predetermined value. The predetermined value of the differential pressure can be externally set by the amount of electric current supplied to the solenoid.

In such a control valve, the high-pressure valve element for introducing refrigerant into the crankcase and the low-pressure valve element for delivering refrigerant from the crankcase are formed integrally with each other, and operate in an interlocked manner. Therefore, this control valve operates such that when it operates to increase the flow rate of refrigerant flowing through one of the refrigerant passage communicating between the discharge chamber and the crankcase and the refrigerant passage communicating between the crankcase and the suction chamber, it operates to reduce the flow rate of refrigerant flowing through the other.

However, since the control valve operates such that one of the high-pressure valve element and the low-pressure valve element is closed and the other is open, as described above, there is necessarily a region in which both the valve elements are open. This permits refrigerant introduced into the crankcase to be immediately delivered to make it difficult to obtain a sufficient compression efficiency.

### SUMMARY OF THE INVENTION

The present invention has been made in view of the problem, and an object thereof is to enable a control valve for a variable displacement compressor, which operates by sensing a differential pressure between discharge pressure and suction pressure or between the discharge pressure and crankcase pressure, to enhance compression efficiency inside the compressor.

To solve the above problem, the present invention provides a control valve for a variable displacement compressor, which controls refrigerant displacement of the compressor by sensing a differential pressure between discharge pressure in a discharge chamber and suction pressure in a suction chamber or a differential pressure between the discharge pressure and crankcase pressure in a crankcase, comprising a first valve element that is fitted to and removed from a first valve hole communicating between the discharge chamber and the crankcase to thereby close and open the first valve hole, a second valve element that is fitted to and removed from a second valve hole communicating between the crankcase and the suction chamber to thereby close and open the second valve hole, and a solenoid that is capable of applying a force in a valve-opening direction to the second valve element via a shaft, thereby making it possible to cause the first valve element and the second valve element to move either independently of or in unison with each other, wherein after the first valve element closes the first valve hole, the second valve element opens the second valve hole.

Further, the present invention provides a control valve for a variable displacement compressor, which controls refrigerant displacement of the compressor by sensing a differential pressure between discharge pressure in a discharge chamber and suction pressure in a suction chamber or a differential pressure between the discharge pressure and crankcase pressure in a crankcase, comprising a first valve that opens and closes a first valve hole communicating between the discharge chamber and the crankcase, a second valve that opens and closes a second valve hole communicating between the crankcase and the suction chamber, and a solenoid that is capable of directly or indirectly applying a force in a valve-opening direction or a valve-closing direction to the first valve and the second valve via a shaft, wherein after the first valve closes the first valve hole, the second valve closes the second valve hole.

The above and other objects, features and advantages of the present invention will become apparent from the following description when taken in conjunction with the accompanying drawings which illustrate preferred embodiment of the present invention by way of example.

### BRIEF DESCRIPTION OF THE DRAWINGS

FIG. 1 is a cross-sectional view showing the construction of a control valve for a variable displacement compressor, according to a first embodiment of the present invention.

FIG. 2 is an enlarged view of an upper portion of the control valve for a variable displacement compressor.

FIG. 3 is a cross-sectional view illustrating the operation of the control valve for a variable displacement compressor.

FIG. 4 is a cross-sectional view illustrating the operation of the control valve for a variable displacement compressor.

FIG. 5 is a cross-sectional view showing the construction of a control valve for a variable displacement compressor, according to a second embodiment of the present invention.

FIG. 6 is an enlarged view of an upper portion of the control valve for a variable displacement compressor.

FIG. 7 is a cross-sectional view showing the construction of a control valve for a variable displacement compressor, according to a third embodiment of the present invention.

FIG. 8 is an enlarged view of an upper portion of the control valve for a variable displacement compressor.

FIG. 9 is a cross-sectional view illustrating the operation of the control valve for a variable displacement compressor.

FIG. 10 is a cross-sectional view illustrating the operation of the control valve for a variable displacement compressor.

FIG. 11 is an enlarged view of an upper portion of a variation of the control valve according to the third embodiment.

FIG. 12 is an enlarged view of an upper portion of a control valve for a variable displacement compressor, according to a fourth embodiment of the present invention.

FIG. 13 is a cross-sectional view showing the construction of a control valve for a variable displacement compressor, according to a fifth embodiment of the present invention.

FIG. 14 is a cross-sectional view showing the construction of a control valve for a variable displacement compressor, according to a sixth embodiment of the present invention.

FIG. 15 is an explanatory view of a variation of the sixth embodiment.

FIG. 16 is an explanatory view of a variation of the sixth embodiment.

FIG. 17 is an explanatory view of a variation of the sixth embodiment.

FIG. 18 is a cross-sectional view showing the construction of a control valve for a variable displacement compressor, according to a seventh embodiment of the present invention.

FIG. 19 is an enlarged view of an upper portion of the control valve for a variable displacement compressor.

FIG. 20 is a plan view showing the construction of a leaf spring.

FIG. 21 is a cross-sectional view illustrating the operation of the control valve for a variable displacement compressor.

FIG. 22 is a cross-sectional view illustrating the operation of the control valve for a variable displacement compressor.

FIG. 23 is a graph showing the relationship between valve opening degrees of a first valve and a second valve with respect to the differential pressure (Pd−Ps) between discharge pressure Pd and suction pressure Ps.

FIG. 24 is an explanatory view of a first variation of the seventh embodiment.

FIG. 25 is an explanatory view of the first variation of the seventh embodiment.

FIG. 26 is an explanatory view of a second variation of the seventh embodiment.

FIG. 27 is an explanatory view of the second variation of the seventh embodiment.

FIG. 28 is an explanatory view of a third variation of the seventh embodiment.

FIG. 29 is a cross-sectional view showing the construction of a control valve for a variable displacement compressor, according to an eighth embodiment of the present invention.

### DESCRIPTION OF THE PREFERRED EMBODIMENTS

Hereinafter, embodiments of the present invention will be described in detail with reference to the drawings. It should be noted in the following description, the positional relations of structures are expressed as “upper” and “lower” or “top” and “bottom” with reference to the illustrated state thereof shown in each figure.

### First Embodiment

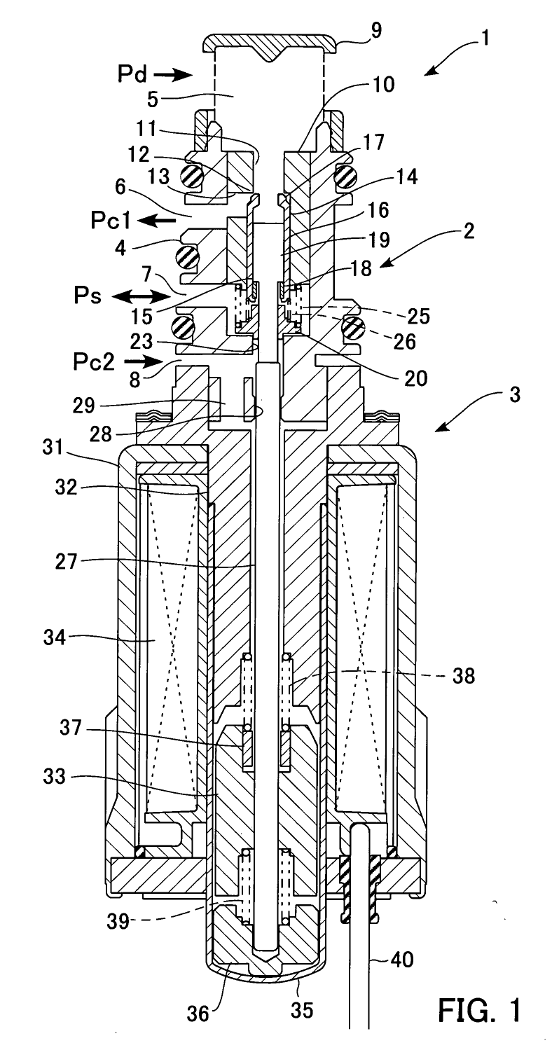

FIG. 1 is a cross-sectional view showing the construction of a control valve for a variable displacement compressor, according to a first embodiment of the present invention.

The control valve 1 is constructed by assembling a three-way valve 2 and a solenoid valve 3 into an integral unit. The three-way valve 2 opens and closes a refrigerant passage for introducing part of refrigerant in a discharge chamber of a variable displacement compressor, not shown, into a crankcase of the same, and a referent passage for delivering refrigerant in the crankcase to a suction chamber. Further, the solenoid valve 3 adjusts the opening degrees of the three-way valve 2 to thereby control the flow rates of refrigerant flowing through the refrigerant passages.

The three-way valve 2 has a body 4 in the form of a stepped hollow cylinder. The top of the body 4 is formed with a port 5 that communicates with the discharge chamber of the compressor to receive discharge pressure Pd therefrom. Further, in a side of the body 4, sequentially from the port 5 side, there are formed a port 6 that communicates with the crankcase of the compressor to deliver pressure Pc1 (referred to as “crankcase pressure”) controlled within the body 4, a port 7 that communicates with the suction chamber of the compressor to receive suction pressure Ps, and a port 8 that communicates with the crankcase to introduce the crankcase pressure Pc2 (=Pc1) delivered from the crankcase.

The body 4 has a strainer 9 fitted on an upper end thereof in a manner covering the port 5. Further, a hollow cylindrical guide member 10 is fitted in an upper end opening of the body 4. The guide member 10 has a stepped portion formed in the vicinity of the upper end thereof such that the guide member 10 has an increased inner diameter downward therefrom, whereby the inner passage of a small-diameter portion of the guide member 10 forms a valve hole 11 (corresponding to “a first valve hole”), and the inner peripheral edge of a downstream end of the valve hole 11 forms a valve seat 12. Further, a side of the guide member 10 where the stepped portion is located is formed with a communication hole 13 that opens laterally, such that the port 5 and the port 6 communicate with each other via the valve hole 11 and the communication hole 13.

A large-diameter portion of the guide member 10 on a downstream side of the valve hole 11 has a valve element 14 (corresponding to “a first valve element”) axially movably inserted therein such that the valve element 14 is fitted to and removed from the valve hole 11, for closing and opening the valve hole 11. Further, a long valve element 15 (corresponding to “a second valve element”) is axially movably disposed in opposed relation to the valve element 14.

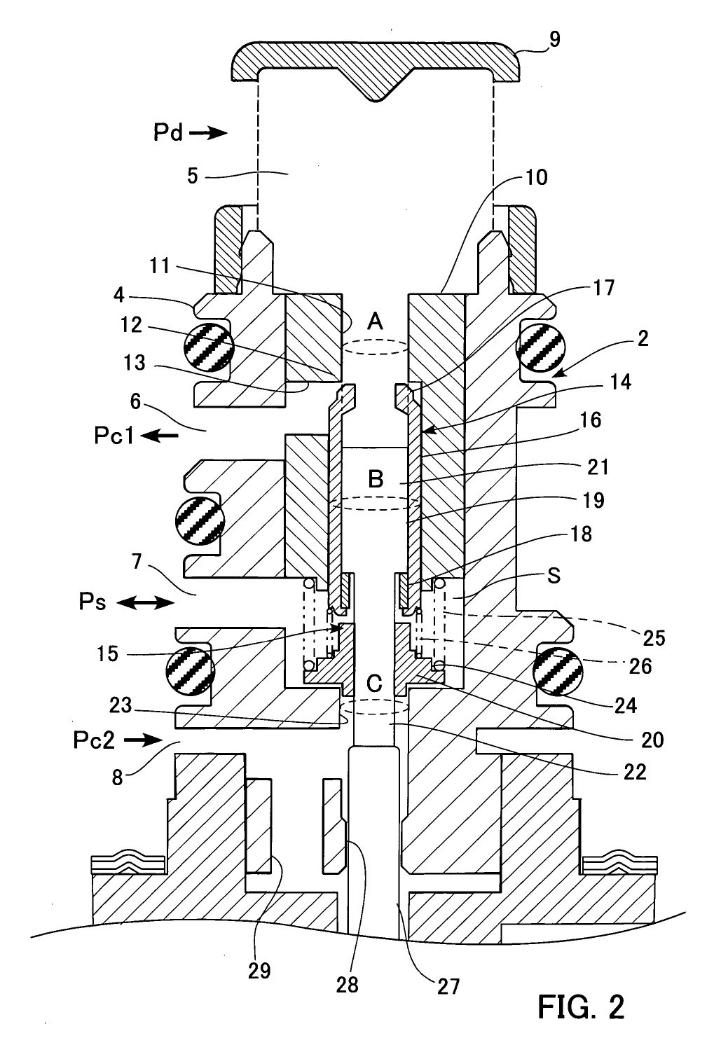

FIG. 2 is an enlarged view of an upper portion of the control valve for a variable displacement compressor.

The valve element 14 has a hollow cylindrical valve main body 16 inserted in the large-diameter portion of the guide member 10, for being axially guided therein, and has a high-pressure valve portion 17 formed at an upstream end of the valve main body 16 such that the diameter of the high-pressure valve portion 17 is slightly reduced to form a tapered shape. The high-pressure valve portion 17 is seated on and removed from the valve seat 12, whereby the refrigerant passage communicating between the port 5 and the port 6 is closed and opened. Further, at a downstream end of the valve main body 16 opposite to the high-pressure valve portion 17 is swaged in a state in which a hollow cylindrical ring 18 is press-fitted therein, and the ring 18 forms a stop portion for stopping the valve element 15. An end of the valve main body 16 where the ring 18 is provided is exposed to a refrigerant space S communicating with the port 7 at a location below the guide member 10.

The valve element 15 comprises a shaft part 19 in the form of a stepped cylinder, and a low-pressure valve portion 20 in the form of a stepped hollow cylinder press-fitted on the shaft part 19. The shaft part 19 has a large-diameter portion 21 formed as an upstream portion thereof inserted into the main valve body 16 of the valve element 14 and guided therein, and a small-diameter portion 22 formed as a downstream portion thereof inserted into a valve hole 23 (corresponding to “a second valve hole”) formed in a downstream portion of the body 4. The valve hole 23 communicates between the port 7 and the port 8 via the refrigerant space S. Further, the small-diameter portion 22 has the low-pressure valve portion 20 provided on the periphery thereof.

The low-pressure valve portion 20 is disposed in the refrigerant space S. The low-pressure valve portion 20 is formed such that a lower end thereof is formed to have an outer diameter which is slightly smaller than the inner diameter of the valve hole 23 formed on an upstream side of the body 4, and is inserted into the valve hole 23 with a predetermined clearance therebetween, thereby functioning as a spool valve that opens and closes the valve hole 23. Further, the low-pressure valve portion 20 has a stepped flange portion 24 formed to extend outward from the vicinity of the lower end thereof. A spring 25 (corresponding to “other urging means”) is interposed between an outward end of the flange portion 24 and a lower end face of the guide member 10, for urging the valve element 15 in a valve-closing direction via the low-pressure valve portion 20. Further, a spring 26 (corresponding to “urging means”) is interposed between an inward end of the flange portion 24 and a lower end portion of the main valve body 16 (i.e. an end opposite to the high-pressure valve portion 17), for urging the valve element 15 in a direction away from the valve element 14.

With the above-described construction, when the valve element 15 moves in the valve-opening direction, the valve element 14 is urged in the valve-closing direction by the spring 16, but the ring 18 is stopped by the large-diameter portion 21 of the shaft part 19, so that the movement of the valve element 14 in the valve-closing direction is restricted. On the other hand, when the valve element 15 moves in the valve-closing direction, the large-diameter portion 21 of the shaft part 19 is engaged with the ring 18 and urges the ring 18 in the same direction, and hence the valve element 14 moves in the valve-opening direction in unison therewith.

Further, when the valve element 15 opens, the upper end of the low-pressure valve portion 20 is stopped by the lower end of the valve main body 16, whereby the amount of lift of the low-pressure valve portion 20 from the valve hole 23 is restricted.

Further, even if the valve hole 23 is closed by the valve element 15, refrigerant introduced from the port 8 slightly flows out via a gap formed between the low-pressure valve portion 20 and the valve hole 23 into the port 7 and delivered into the suction chamber. Then, when the valve element 15 is open, refrigerant flows from the port 8 into the port 7 at a flow rate to be normally assumed when the valve element 15 is open. That is, by causing refrigerant to slightly flow without completely blocking the refrigerant passage even when the valve element 15 is closed, introduction of refrigerant into the crankcase from the discharge chamber is promoted. On the other hand, by making the refrigerant passage very small when the valve element 15 is closed, as described above, refrigerant introduced into the crankcase is prevented from being immediately delivered, thereby improving the compression efficiency of the compressor. It should be noted that the gap between the low-pressure valve portion 20 and the valve hole 23 may be reduced to substantially zero, thereby preventing refrigerant from flowing from the port 8 into the port 7 when the valve element 15 is closed.

The control valve 1 constructed as above has a pressure-canceling structure that purely senses only the discharge pressure Pd and the suction pressure Ps, thereby functioning as a Pd-Ps valve that controls the valve opening degree of the valve element 14 (i.e. the amount of lift thereof from the valve seat 12).

More specifically, as shown in FIG. 2, in the control valve 1, the cross-sectional area of the valve hole 11 is represented by A, the cross-sectional area of the large-diameter portion of the guide member 10 which guides the valve element 14 by B, and the cross-sectional area of the valve hole 23 by C (=B−A). Therefore, the force f by the pressure of refrigerant applied to the combined body of the valve element 14 and the valve element 15 is as follows:
f=A·Pd+(B−A)·Pc1−(B−A)·Pc2+(B−A)·Ps−B·Ps=A·(Pd−Ps)

wherein the valve-opening direction of the valve element 14 is defined as positive (plus).

Therefore, the crankcase pressures Pc (Pc1 and Pc2) applied to the combined body of the valve element 14 and the valve element 15 are cancelled out, whereby the valve element 14 moves in the valve-opening or valve-closing direction by purely sensing the differential pressure (Pd−Ps) between the discharge pressure Pd and the suction pressure Ps.

Referring back to FIG. 1, the solenoid 3 comprises a core 32 fixed to a case 31, a plunger 33 for moving back and forth the valve element 15 via the shaft 27 so as to open and close the three-way valve 2, and an electromagnetic coil 34 externally supplied with electric current for generating an electromagnetic circuit including the core 32 and the plunger 33.

The core 32 is fixed to the body 4 by press-fitting a lower end of the body 4 into an upper end opening of a hollow cylindrical main body thereof. The core 32 is formed with an insertion hole that axially extends through the center thereof for having an upper half of the shaft 27 inserted therein. The shaft 27 has an upper end thereof slidably supported in a guide hole 28 formed in the center of a lower end of the body 4. The shaft 27 is disposed substantially on the same axis as that of the shaft part 19 of the valve element 15, and has an upper end of the shaft 27 is in contact with a lower end of the shaft part 19. It should be noted that the lower end of the body 4 has a refrigerant passage 29 formed therein such that the refrigerant passage extends in parallel with the guide hole 28, for communicating between the inside of the solenoid 3 and the port 8.

The core 32 has a lower half thereof inserted into an upper half of a bottomed sleeve 35 having an closed lower end. Within the bottomed sleeve 35, the plunger 33 is made integral with the shaft 27, and axially movably supported at a location below the core 32. The crankcase pressure Pc introduced from the port 8 is introduced into the bottomed sleeve 35 via the refrigerant passage 29.

Further, a bearing member 36 is fixedly disposed at the lower end within the bottomed sleeve 35, for slidably supporting the lower end of the shaft 27. The plunger 33 is fitted on a longitudinal lower portion of the shaft 27. The plunger 33 has a spring-receiving member 37 fitted in the upper end opening thereof, and is urged downward by a spring 38 interposed between the core 32 and the spring-receiving member 37, and on the other hand urged upward by a spring 39 interposed between the same and the bearing member 36. Further, by changing the amount of fitting insertion of the spring receiving member 37 into the plunger 33, the spring load given by the spring 38 to the plunger 33 can be adjusted. The electromagnetic coil 34 is arranged around the outer periphery of the bottomed sleeve 35, and a harness 40 for supplying electricity to the coil 34 extends out of the valve 1.

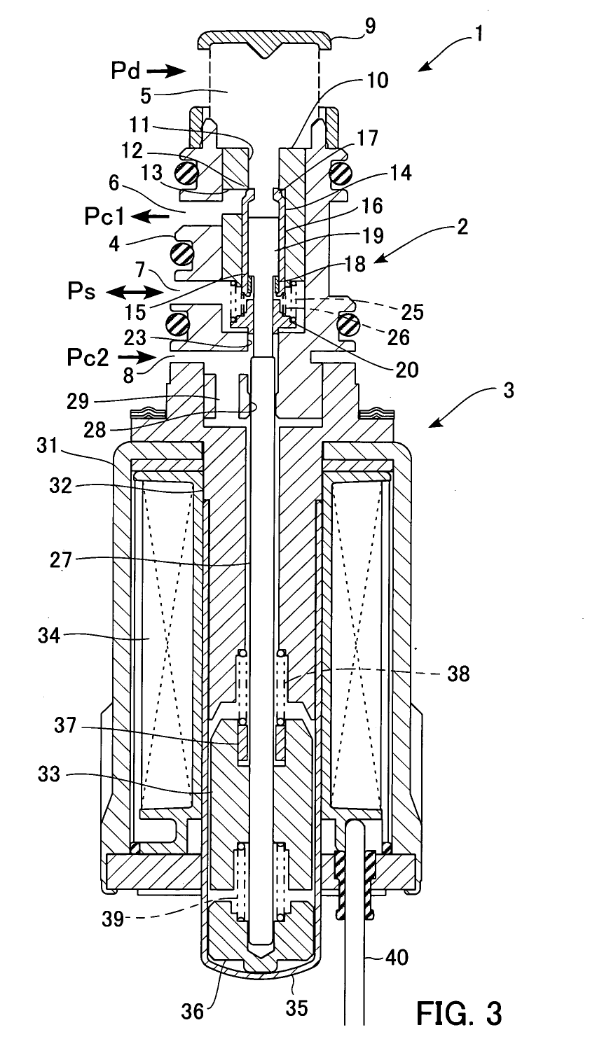

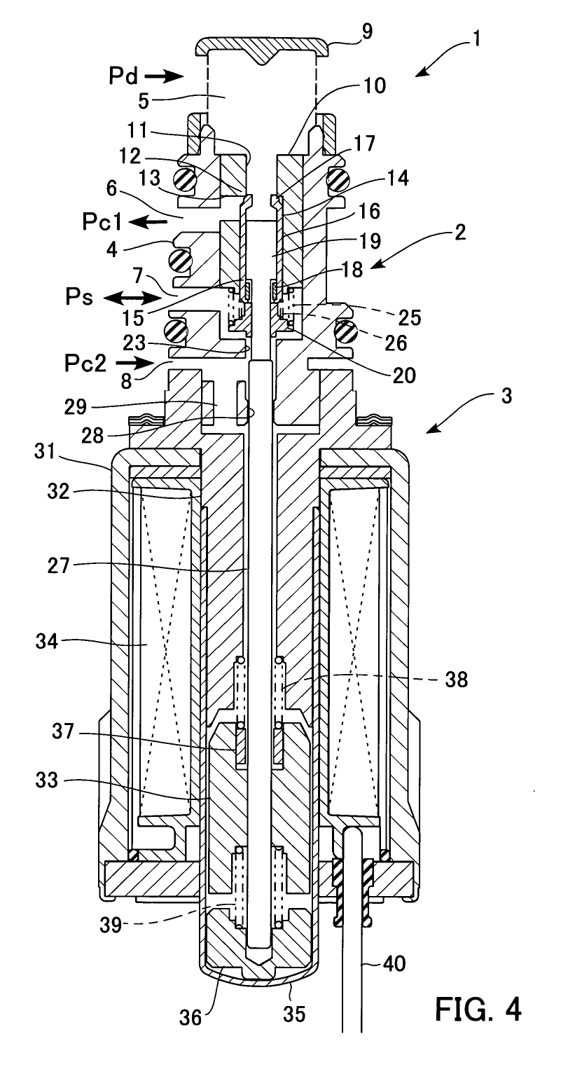

Next, the operation of the control valve 1 for a variable displacement compressor will be described with reference to FIGS. 1 to 4. FIGS. 3 and 4 are cross-sectional views showing the operation of the control valve.

When the solenoid 3 is not energized, as shown in FIG. 1, the high-pressure Pd-Pc valve which is formed by the high-pressure valve portion 17 and the valve seat 12 is fully open, and the low-pressure Pd-Ps valve which is formed by the low-pressure valve portion 20 and the valve hole 23 is fully closed. At this time, when the discharge pressure Pd is introduced from the discharge chamber of the variable displacement compressor, the discharge pressure Pd is introduced into the crankcase via the Pd-Pc valve while being changed into the crankcase pressure Pc1. The refrigerant passage extending from the crankcase to the suction chamber is substantially closed by the Pc-Ps valve, and hence the crankcase pressure Pc1 (=Pc2) assumes a value close to the discharge pressure Pd, and the difference in pressures applied to the both sides of each piston becomes minimum, so that the wobble plate is at such an inclination angle that minimizes the stroke of the piston. This controls the variable displacement compressor to the minimum displacement operation. It should be noted that as described hereinabove, although the Pc-Ps valve is substantially closed, the crankcase pressure Pc2 is slightly delivered into the suction chamber via the gap between the low-pressure valve portion 20 and the valve hole 23, whereby introduction of refrigerant from the discharge chamber into the crankcase is promoted.

Now, if the electric current supplied to the solenoid 3 is increased, as shown in FIG. 3, the plunger 33 is attracted by the core 32 to move upward, and the shaft 27 fixed to the plunger 33 also moves upward. This causes the valve element 15 to move upward, whereby the valve element 14 urged by the spring 26 also moves in the valve-closing direction. Then, after the valve element 14 is closed, the valve element 15 starts to open (load of the spring 26 is so set). During this process, the crankcase pressure Pc2 is delivered through the gap between the low-pressure valve portion 20 and the valve hole 23 into the suction chamber, so that the crankcase pressure Pc1 progressively decreases. As a result, the variable displacement compressor is controlled to the operation with the displacement corresponding to the value of electric current supplied to the solenoid 3.

Then, when a predetermined electric current is supplied to the solenoid 3, the Pd-Pc valve and the Pc-Ps valve are controlled to respective valve opening degrees corresponding to the value of the predetermined electric current. At this time, when the engine speed, i.e. the rotational speed of the compressor has changed to change the differential pressure between the discharge pressure Pd and the suction pressure Ps, the control valve 1 performs control such that the change in the differential pressure changes the strokes of the Pd-Pc valve and the Pc-Ps valve to change the displacement of the compressor, whereby the differential pressure between the discharge pressure Pd and the suction pressure Ps is maintained at a predetermined differential set by the solenoid current.

Further, particularly when an automotive air conditioner is started or when the cooling load is maximum, the value of electric current supplied to the solenoid 3 is maximum. At this time, as shown in FIG. 4, the plunger 33 is attracted with the maximum attractive force by the core 32, so that the valve element 14 is united with the low-pressure valve portion 20 of the valve element 15 to move in the valve-closing direction, whereby the high-pressure valve portion 17 of the valve element 14 is seated on the valve seat 12 to place the high-pressure valve portion 17 in the fully closed state. At this time, the high-pressure refrigerant at the discharge pressure Pd, introduced into the port 5, is prevented from being delivered to the port 6, so that in the variable displacement compressor, the crankcase pressure Pc becomes close to the suction pressure Ps, which causes the compressor to perform the maximum displacement operation.

As described heretofore, in the control valve 1 according to the present embodiment, after the valve element 14 on the high-pressure side closes the valve hole 11, the valve element 15 on the low-pressure side opens the valve hole 23. Therefore, it is possible to eliminate the region wherein the valves on the high-pressure side and the low-pressure side are simultaneously open. This makes it possible to prevent the refrigerant introduced into the crankcase from being immediately delivered. As a result, it is possible to obtain a sufficient compression efficiency.

Further, e.g. when the variable displacement compressor is started, the Pc-Ps valve is fully opened, the oil and the like collected within the crankcase are immediately discharged into the suction chamber, whereby the response of control can be enhanced.

### Second Embodiment

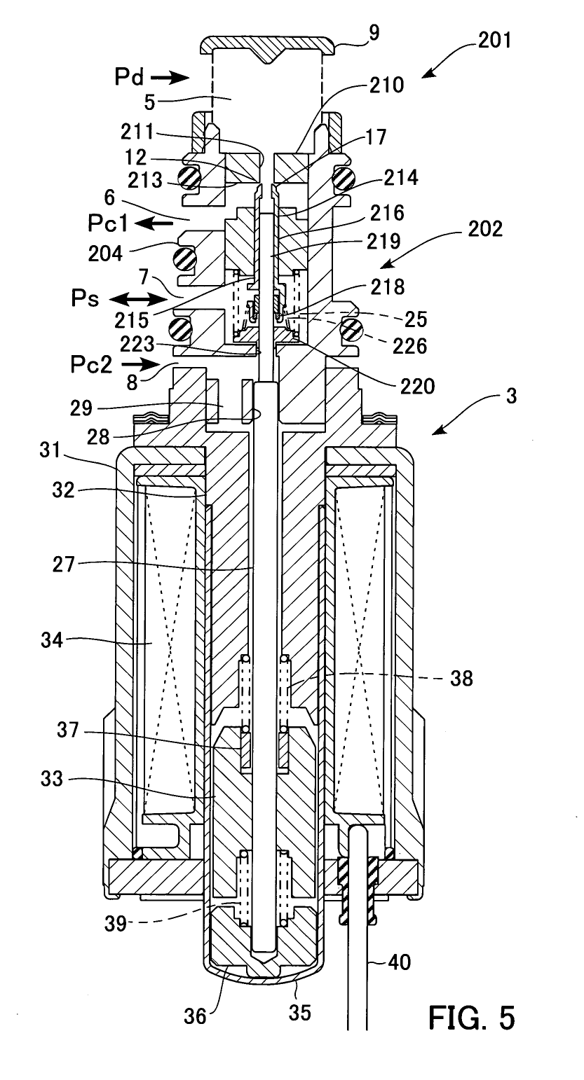

Next, a second embodiment of the present invention will be described. The control valve for a variable displacement compressor, according to the present embodiment, has substantially the same construction as that of the first embodiment except that the construction of the three-way valve is different. Therefore, component elements substantially identical to those of the first embodiment are designated by the same reference numerals, and description thereof is omitted as deemed appropriate. FIG. 5 is a cross-sectional view showing the construction of the control valve according to the present embodiment.

In the control valve 201 for a variable displacement compressor, a hollow cylindrical guide member 210 is fitted in an upper end opening of the body 204 of the three-way valve 202. The inner passage of a small-diameter portion of the guide member 210 forms a valve hole 211 (corresponding to “a first valve hole”), and the inner diameter of the valve hole 211 is smaller than that of the valve hole 11 in the first embodiment, which makes it suitable for dealing with high-pressure refrigerant (Co₂ or the like). The stepped portion of the guide member 210 has a side thereof formed with a communication hole 213 communicating with the port 6.

A large-diameter portion of the guide member 210 has a valve element 214 (corresponding to “a first valve element”) axially movably inserted therein such that the valve element 214 is fitted to and removed from the valve hole 211, for closing and opening the valve hole 211. Further, a long valve element 215 (corresponding to “a second valve element”) is axially movably disposed in opposed relation to the valve element 214.

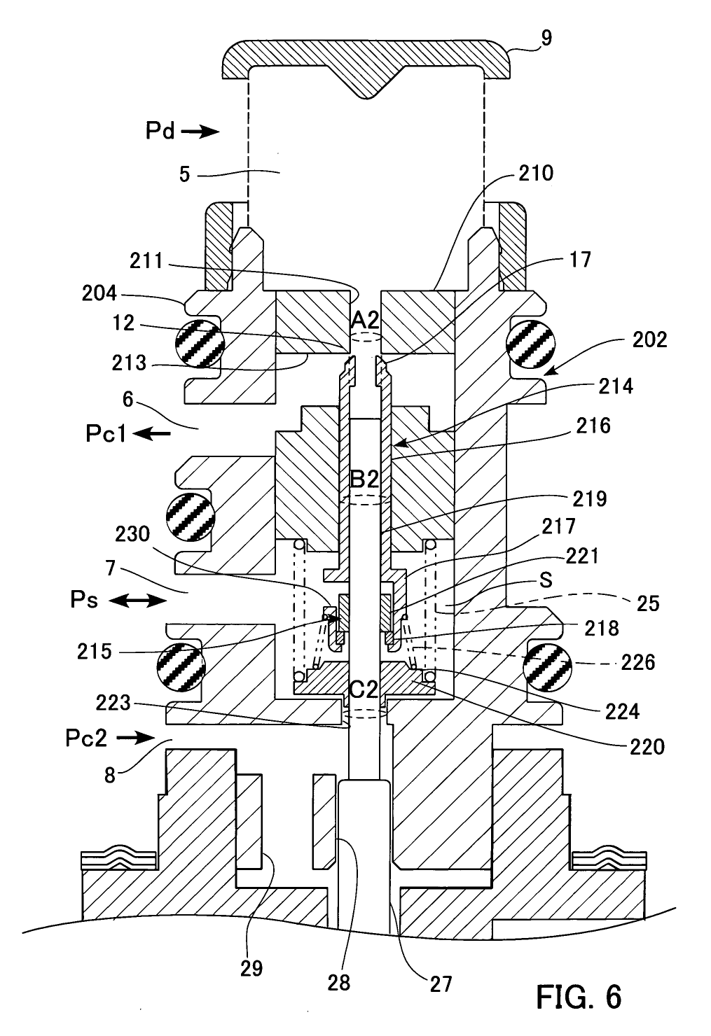

FIG. 6 is an enlarged view of an upper portion of the control valve for a variable displacement compressor.

The valve element 214 has a valve main body 216 in the form of a stepped hollow cylinder inserted into the large-diameter portion (corresponding to “a guide hole”) of the guide member 210, for being axially guided therein, and has a high-pressure valve portion 17 formed at an upstream end of the valve main body 216. Further, on an opposite side to the high-pressure valve portion 17 of the valve main body 16, an increased-diameter portion 217 is formed which is exposed into a refrigerant space S, and a foremost end of the increased-diameter portion 217 is swaged in a state in which a hollow cylindrical ring 218 (corresponding to “a stop portion”) is press-fitted therein. Further, the increased-diameter portion 217 has a side thereof formed with an opening 230 opening into the refrigerant space S.

The valve element 215 comprises a shaft part 219 in the form of a cylinder, and a low-pressure valve portion 220 in the form of a stepped hollow cylinder press-fitted on the shaft part 219. The shaft part 219 has a stop ring 221 press-fitted on a central portion thereof, in axially opposed relation to the ring 218, with an upper half thereof upstream of the stop ring 221 inserted into the main valve body 216 of the valve element 214, for being guided therealong. Further, a downstream portion of the shaft part 219 with respect to the stop 221 is inserted into a valve hole 223 (corresponding to “a second valve hole”) formed in a downstream portion of the body 204, and has the low-pressure valve portion 220 provided on the periphery thereof.

The low-pressure valve portion 220 is formed such that a lower end thereof is formed to have an outer diameter which is slightly smaller than the inner diameter of the valve hole 223, and is inserted into the valve hole 223 with a predetermined clearance therebetween, thereby functioning as a spool valve that opens and closes the valve hole 223. Further, the low-pressure valve portion 220 has a stepped flange portion 224 formed to extend outward from the vicinity of the lower end thereof. A spring 25 (corresponding to “other urging means”) is interposed between an outward end of the flange portion 224 and a lower end face of the guide member 210. Further, a conical spring 226 (corresponding to “urging means”) is interposed between an inward end of the flange portion 224 and the increased-diameter portion 217 of the valve element 214, for urging the valve element 214 in a direction away form the valve element 215.

With the above-described construction, when the valve element 215 moves in the valve-opening direction, the valve element 214 is urged in the valve-closing direction by the spring 216, but the ring 218 is stopped by the stop ring 221 of the shaft part 219, so that the movement of the valve element 214 in the valve-closing direction is restricted. On the other hand, when the valve element 215 moves in the valve-closing direction, the stop ring 221 of the shaft part 219 is engaged with the ring 218 and urges the same in the same direction, so that the valve element 214 moves in the valve-opening direction in unison with the valve element 215.

Further, when the valve element 215 opens, an end of the low-pressure valve portion 220 opposite to an end which is inserted into and removed from the valve hole 223 is stopped by the lower end of the increased-diameter portion 217, whereby the amount of lift of the low-pressure valve portion 220 from the valve hole 223 is restricted.

Further, even if the valve hole 223 is closed by the valve element 215, refrigerant introduced from the port 8 slightly flows out via a gap formed between the low-pressure valve portion 220 and the valve hole 223 into the port 7 and is delivered into the suction chamber. Then, when the valve element 215 is open, refrigerant flows from the port 8 into the port 7 at a flow rate to be normally assumed when the valve element 215 is open. That is, by causing refrigerant to slightly flow without completely blocking the refrigerant passage even when the valve element 15 is closed, introduction of refrigerant into the crankcase from the discharge chamber is promoted. On the other hand, by making the refrigerant passage very small when the valve element 215 is closed, as described above, refrigerant introduced into the crankcase is prevented from being immediately delivered, thereby improving the compression efficiency of the compressor.

In the control valve 201 for a variable displacement compressor as well, the cross-sectional area of the valve hole 211 is represented by A2, that of the large-diameter portion of the guide member 210 by B2, and that of the valve hole 223 by C2 (=B2−A2). Therefore, the crankcase pressures Pc (Pc1 and Pc2) applied to the combined body of the valve element 214 and the valve element 215 are cancelled out, whereby the valve element 214 moves in the valve-opening or valve-closing direction by purely sensing the differential pressure (Pd−Ps) between the discharge pressure Pd and the suction pressure Ps.

It should be noted that the control valve 201 for a variable displacement compressor operates substantially in the same manner as the control valve 1 according to the first embodiment, and hence description of the operation is omitted.

As described hereinabove, in the control valve 201 according to the present embodiment, after the valve element 214 on the high-pressure side closes the valve hole 211, the valve element 215 on the low-pressure side opens the valve hole 223. Therefore, it is possible to eliminate a region wherein the valves on the high-pressure side and the low-pressure side open simultaneously. This makes it possible to prevent the refrigerant introduced into the crankcase from being immediately delivered. As a result, it is possible to obtain a sufficient compression efficiency.

### Third Embodiment

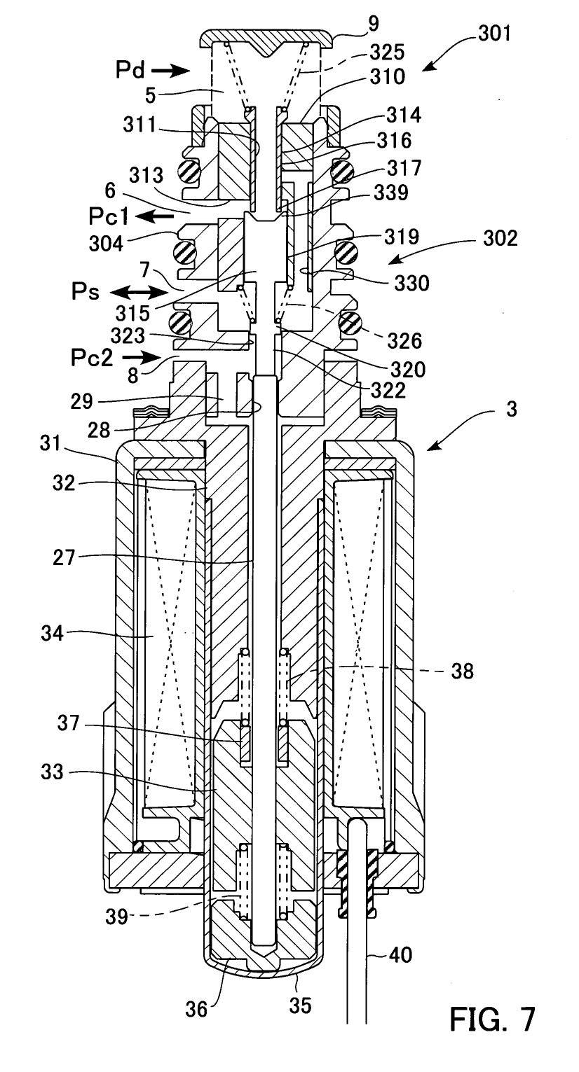

Next, a third embodiment of the present invention will be described. The control valve for a variable displacement compressor, according to the present embodiment, has substantially the same construction as that of the first embodiment except that the construction of the three-way valve is different. Therefore, component elements substantially identical to those of the first embodiment are designated by the same reference numerals, and description thereof is omitted as deemed appropriate. FIG. 7 is a cross-sectional view showing the construction of the control valve according to the present embodiment.

In the control valve 301 for a variable displacement compressor, a guide member 310 in the form of a hollow cylinder is fitted in an upper end opening of a body 304 of a three-way valve 302. A small-diameter portion of the guide member 310 has a valve element 314 (corresponding to “a first valve element”) axially slidably inserted therein, and the internal passage of the valve element 314 defines a valve hole 311 (corresponding to “a first valve hole”). The stepped portion of the valve hole 11 has sides formed with a communication hole 313 communicating with the port 6 and a communication hole 330 which axially extends to communicate with the port 7.

A large-diameter portion of the guide member 310 has a long valve element 315 (corresponding to “a second valve element”) axially slidably disposed therein in opposed relation to the valve element 314.

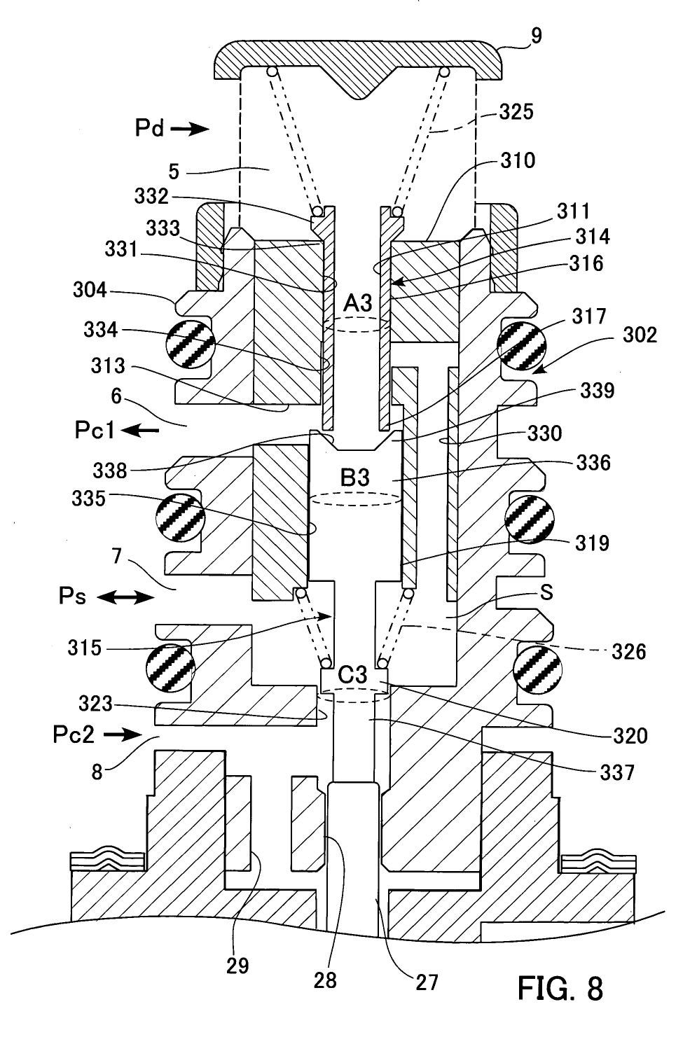

FIG. 8 is an enlarged view of an upper portion of the control valve for a variable displacement compressor.

The valve element 314 has a valve main body 316 in the form of a hollow cylinder inserted into a small-diameter portion 331 (corresponding to “a guide hole”) of the guide member 310, for being axially guided therein, and a downstream end of the valve element 314 forms a high-pressure valve portion 317. Further, an upstream end of the valve element 316 opposite to the high-pressure valve portion 317 is formed with a tapered sealing portion 332 the diameter of which increases as it extends upward. The sealing portion 332 is configured such that it can be seated on and removed from a valve seat 333 formed by the rim of an opening at an upstream end of the small-diameter portion 331. When seated on the valve seat 333, the sealing portion 332 closes the clearance between the small-diameter portion 331 and the valve element 316, from above. Further, the small-diameter portion 331 has a lower half thereof slightly increased in diameter, and this increased-diameter portion 334 communicates with the refrigerant space S via the aforementioned communication hole 330. Between the sealing portion 332 and the strainer 9, there is disposed a conical spring 325 for urging the vale element 314 in the valve-closing direction.

The valve element 315 comprises a shaft part 319 in the form of a stepped cylinder which is axially guided by the large-diameter portion 335 of the guide member 310, and a low-pressure valve portion 320 which is inserted into and removed from a valve hole 323 (corresponding to “a second valve hole”) formed in a downstream portion of the body 304, for closing and opening the valve hole 323.

The shaft part 319 comprises a large-diameter portion 336 that is slidably inserted into the large-diameter portion 335 of the guide member 310, and a small-diameter portion 337 partially inserted into the valve hole 323, and is disposed substantially on the same axis as that of the shaft 27. The large-diameter portion 336 has an upstream end thereof formed with a recess 338 having a tapered sloping surface which forms a valve seat portion 339 for being brought into and out of contact with the high-pressure valve portion 317. That is, the valve element 314 and the valve element 315 cooperatively open and close the valve hole 311. The small-diameter portion 337 has a low-pressure valve portion 320 formed on the periphery of a central portion thereof.

The low-pressure valve portion 320 is formed such that the outer diameter thereof is slightly smaller than the inner diameter of the valve hole 323, and is inserted into the valve hole 323 with a predetermined clearance therebetween, thereby functioning as a spool valve that opens and closes the valve hole 323. A conical spring 326 is interposed between an upper end face of the low-pressure valve portion 320 and a lower end face of the guide member 310, for urging the low-pressure valve portion 320 in a valve-closing direction.

With the above-described construction, the movement of the valve element 314 in the valve-closing direction (downward as viewed in FIG. 8) is restricted, as illustrated therein, by having the sealing portion 332 seated on the valve seat 333. Therefore, in the illustrated state in which the solenoid 3 is not energized, the valve element 315 is urged downward by the spring 326 to move downward, which places the Pd-Pc valve in the closed state. On the other hand, the valve element 314 is open due to the downward displacement of the valve element 315.

On the other hand, when the valve element 315 moves in the valve-opening direction (upward as viewed in FIG. 8), the high-pressure valve portion 317 of the valve element 314 is seated on the valve seat portion 339 of the valve element 315 to close the Pd-Pc valve. Even if the valve element 314 moves further upward, since the valve element 314 and the valve element 315 move in unison with each other, the closed state of the Pd-Pc valve is maintained. After the Pd-Pc valve is thus closed, the low-pressure portion 320 of the valve element 315 is lifted from the valve hole 323, whereby the Pd-Ps valve is opened (the load of the spring 326 is so set).

Further, when the valve element 315 opens, the urging force of the spring 316 limits the amount of lift of the low-pressure valve portion 320 from the valve hole 323.

Further, even when the valve hole 323 is closed by the valve element 315, refrigerant introduced from the port 8 slightly flows out via a gap formed between the low-pressure valve portion 320 and the valve hole 323 into the port 7 and is delivered into the suction chamber. Then, when the Pc-Ps valve is open, refrigerant flows from the port 8 into the port 7 at a flow rate to be normally assumed when the Pc-Ps valve is open. That is, by causing refrigerant to slightly flow without completely blocking the refrigerant passage when even the valve element 315 is closed, as described above, introduction of refrigerant into the crankcase from the discharge chamber is promoted. On the other hand, by making the refrigerant passage very small when the valve element 315 is closed, as described above, refrigerant introduced into the crankcase is prevented from being immediately delivered, thereby improving the compression efficiency of the compressor.

In the control valve 301 for a variable displacement compressor as well, the cross-sectional area of the small-diameter portion 331 of the guide member 331 is represented by A3, that of the large-diameter portion 335 by B3, and that of the valve hole 323 by C3 (=B3−A3). Therefore, the crankcase pressures Pc (Pc1 and Pc2) applied to the combined body of the valve element 314 and the valve element 315 are cancelled out, whereby the valve element 314 moves in the valve-opening or valve-closing direction by purely sensing the differential pressure (Pd−Ps) between the discharge pressure Pd and the suction pressure Ps.

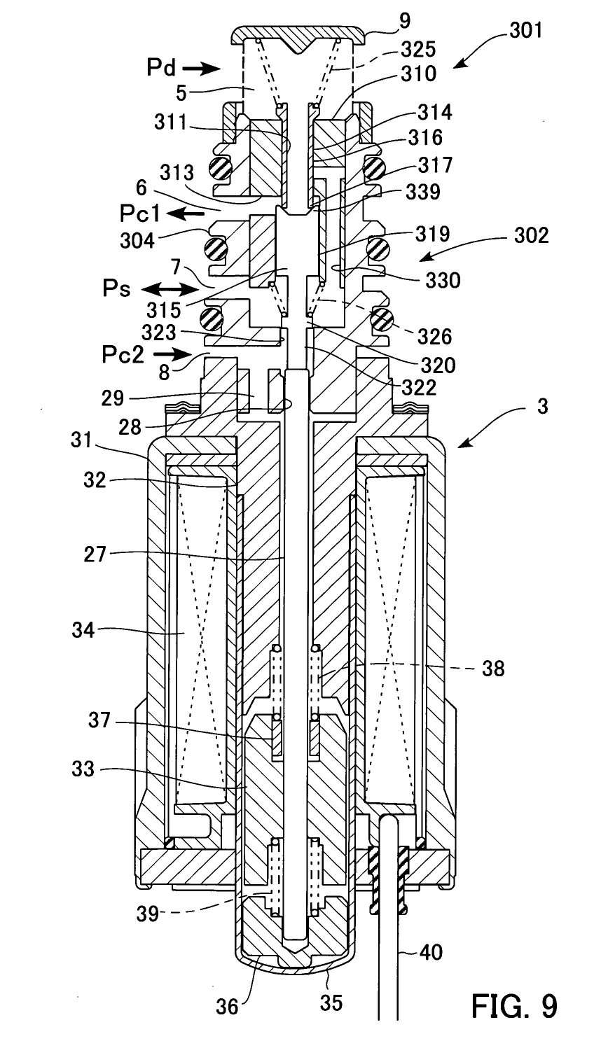

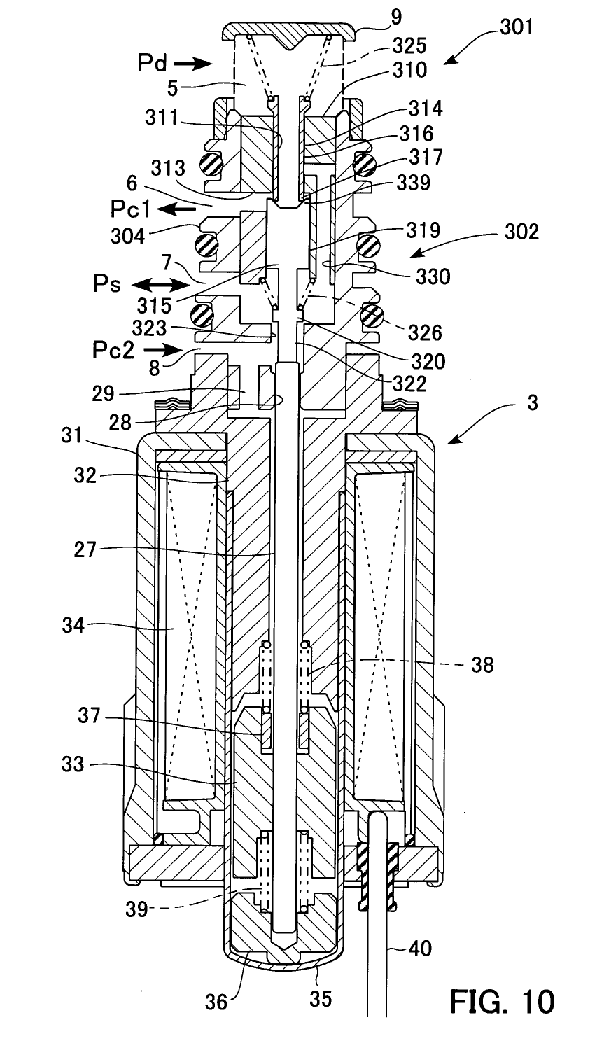

Next, the operation of the control valve 301 for a variable displacement compressor will be described with reference to FIGS. 7 to 10. FIGS. 9 and 10 are cross-sectional views showing the operation of the control valve.

When the solenoid 3 is not energized, as shown in FIG. 8, the valve element 314 and the valve element 315 separate from each other, which makes the high-pressure Pd-Pc valve fully open, and the low-pressure Pd-Ps valve fully closed. At this time, when the discharge pressure Pd is introduced from the discharge chamber of the variable displacement compressor, the discharge pressure Pd is introduced into the crankcase via the Pd-Pc valve while being changed into the crankcase pressure Pc1 (=Pc2). The refrigerant passage extending from the crankcase to the suction chamber is substantially closed by the Pc-Ps valve, and hence the crankcase pressure Pc1 assumes a value close to the discharge pressure Pd, and the difference in pressures applied to the both sides of each piston becomes minimum, so that the wobble plate is at such an inclination angle that minimizes the stroke of the piston. This controls the variable displacement compressor to the minimum displacement operation. It should be noted that as described hereinabove, although the Pc-Ps valve is substantially closed, the crankcase pressure Pc2 is slightly delivered into the suction chamber via the gap between the low-pressure valve portion 320 and the valve hole 323, whereby introduction of refrigerant from the discharge chamber into the crankcase is promoted.

It should be noted that since the sealing portion 332 of the valve element 315 is seated on the valve seat 333 to close the upstream end of the clearance between the small-diameter portion 331 and the valve main body 316, dirt or foreign matter is prevented from flowing into the clearance.

Now, if the electric current supplied to the solenoid 3 is increased, as shown in. FIG. 9, the plunger 33 is attracted by the core 32 to move upward, and the shaft 27 fixed to the plunger 33 also moves upward. This causes the valve element 315 to move upward, whereby the high-pressure portion 317 of the valve element 314 is seated on the valve seat portion 339 of the valve element 315 to close the Pd-Pc valve. Then, from this state, when the valve element 315 moves further upward, the Pd-Ps valve starts to open. At this time, the crankcase pressure Pc2 is delivered through the gap between the low-pressure valve portion 320 and the valve hole 323 into the suction chamber, so that the crankcase pressure Pc1 progressively decreases. As a result, the variable displacement compressor is controlled to the operation with the displacement corresponding to the value of electric current supplied to the solenoid 3. Further, at this time, even if the sealing portion 332 is lifted from the valve seat 333, to allow the high-pressure refrigerant at the discharge pressure Pd to leak through the clearance between the small-diameter portion 331 and the valve main body 316, or dirt to flow into the clearance, the refrigerant or dirt flows out into the increased-diameter portion 334, and then is delivered into the suction chamber via the communication hole 330 and the port 7. As a result, it is possible to prevent the high-pressure refrigerant or dirt from being delivered into the crankcase to cause an erroneous control operation.

Then, when a predetermined electric current is supplied to the solenoid 3, the Pd-Pc valve and the Pc-Ps valve are controlled to respective valve opening degrees corresponding to the value of the predetermined electric current. At this time, when the engine speed, i.e. the rotational speed of the compressor has changed to change the differential pressure between the discharge pressure Pd and the suction pressure Ps, the control valve 1 performs control such that the change in the differential pressure changes the strokes of the Pd-Pc valve and the Pc-Ps valve to change the displacement of the compressor, whereby the differential pressure between the discharge pressure Pd and the suction pressure Ps is maintained at a predetermined differential set by the solenoid current.

Further, particularly when an automotive air conditioner is started or when the cooling load is maximum, the value of electric current supplied to the solenoid 3 is maximum. At this time, as shown in FIG. 10, the plunger 33 is attracted with the maximum attractive force by the core 32, so that the valve element 314 is united with the valve element 315 to move in the valve-closing direction. At this time, the high-pressure refrigerant at the discharge pressure Pd, introduced into the port 5, is prevented from being delivered to the port 6, so that in the variable displacement compressor, the crankcase pressure Pc becomes close to the suction pressure Ps, which causes the compressor to perform the maximum displacement operation. Further, as this time, as illustrate in FIG. 10, although the sealing portion 332 of the valve element 314 is lifted from the valve seat 333, since the differential pressure between the discharge pressure Pd and the suction pressure Ps is small at the start of the compressor, high-pressure refrigerant or dirt scarcely flows in via the clearance between the valve element 315 and the guide member 310.

As described heretofore, in the control valve 301 according to the present embodiment, after the valve element 314 on the high-pressure side closes the valve hole 311, the valve element 315 on the low-pressure side opens the valve hole 323. Therefore, it is possible to eliminate the region wherein the valves on the high-pressure side and the low-pressure side are simultaneously open. This makes it possible to prevent the refrigerant introduced into the crankcase from being immediately delivered. As a result, it is possible to obtain a sufficient compression efficiency.

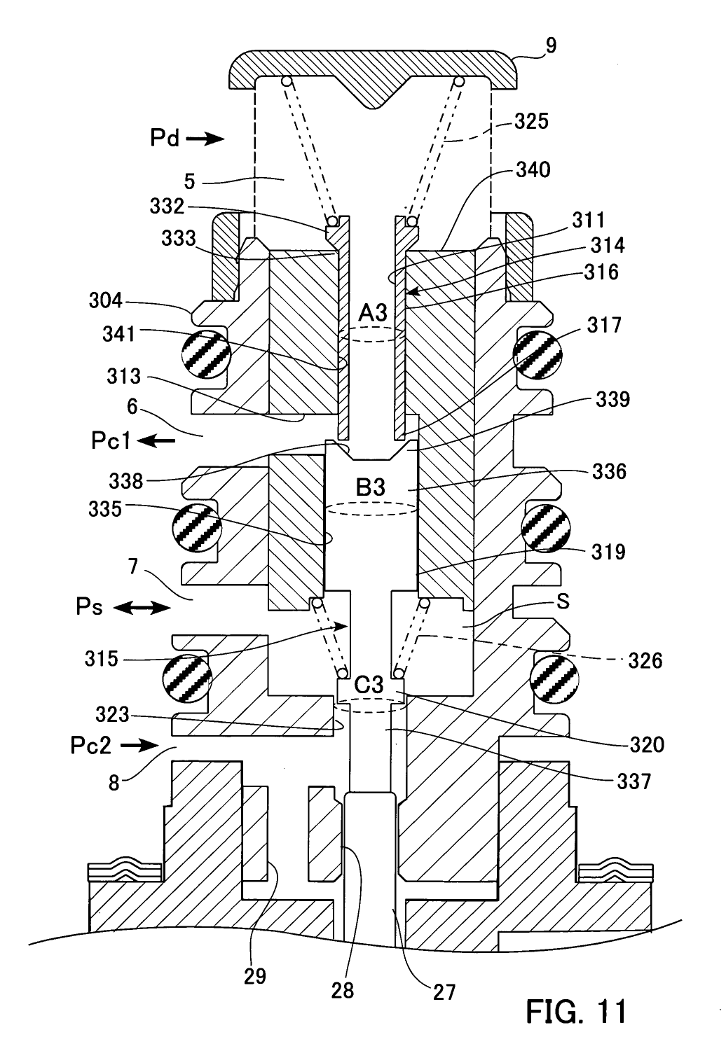

Although in the present embodiment, to prevent high-pressure refrigerant or dirt from flowing into the crankcase, the guide member 310 is formed with the increased-diameter portion 334 and the communication passage 330, these can be omitted. FIG. 11 is an enlarged view of an upper portion of a variation of the control valve according to the third embodiment.

That is, as shown in FIG. 11, the inner diameter of the small-diameter hole 341 of the guide member 340 may be fixed in the axial direction, without provision of a communication passage formed in parallel with the large-diameter portion 335 to communicate with the refrigerant space S.

### Fourth Embodiment

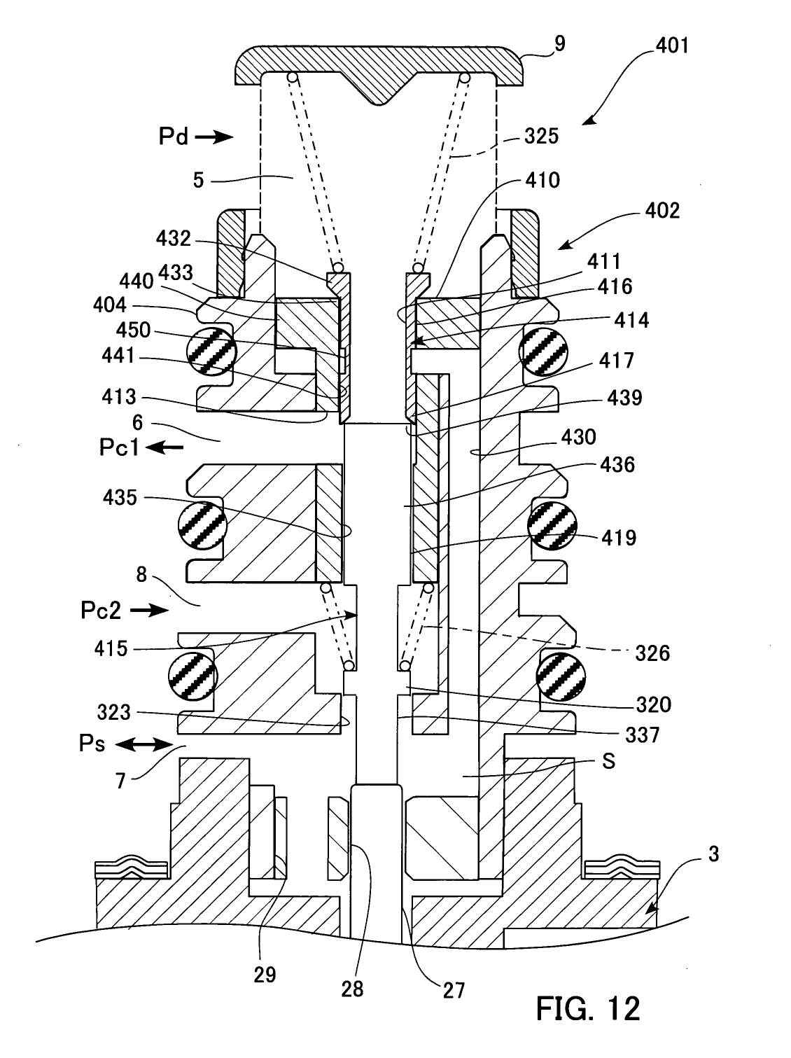

Next, a fourth embodiment of the present invention will be described. The control valve for a variable displacement compressor, according to the present embodiment, has substantially the same construction as that of the third embodiment except that the arrangement of the ports is different. Therefore, component elements substantially identical to those of the third embodiment are designated by the same reference numerals, and description thereof is omitted as deemed appropriate. FIG. 12 is an enlarged view of an upper portion of the control valve according to the present embodiment.

In the control valve 401 for a variable displacement compressor, in a side of the body 404 of a three-way valve 402, sequentially from toward the port 5, there are formed a port 6 that communicates with the crankcase to deliver crankcase pressure Pc1, a port 8 that communicates with the crankcase to introduce the crankcase pressure Pc2, and a port 7 that communicates with the suction chamber to receive suction pressure Ps. Therefore, the suction pressure Ps introduced from the port 7 is introduced into the bottomed sleeve 35 (see FIG. 7) of the solenoid 3 via the refrigerant passage 29.

The body 404 has a guide member 410 in the form of a stepped hollow cylinder inserted into an opening at an upper end thereof, and a portion outward of the opening at the upper end is formed with a communication hole 430 that communicates between the port 5 and the refrigerant space S. The guide member 410 has an upper end thereof formed with a flange 440 that extends outward, and a passage formed between the flange portion 440 and an upper end face of the body 404 communicates with the communication hole 430.

The guide member 410 has a lower half of the inner passage thereof slightly reduced in diameter, and a side thereof formed with a communication hole 413 in the vicinity of the reduced-diameter portion, for communication with the port 6. A large-diameter portion of the guide member 410 has a valve element 414 (corresponding to “a first valve element”) axially slidably inserted therein, and the internal passage of the valve element 414 forms a valve hole 411 (corresponding to “a first valve hole”). Further, a small-diameter portion of the guide member 410 has a long valve element 415 (corresponding to “a second valve element”) axially slidably inserted therein in opposed relation to the valve element 414.

The valve element 414 has a valve main body 416 in the form of a hollow cylinder inserted in the large-diameter portion 441 (corresponding to “a guide hole”) of the guide member 410, for being axially guided therein, and a downstream end of the valve element 414 forms a high-pressure valve portion 417. Further, an upstream end of the valve element 416 is formed with a tapered sealing portion 432 the diameter of which increases at it extends upward. The sealing portion 432 is configured such that it can be seated on and removed from a valve seat 433 formed by the rim of an opening at the upstream end of the large-diameter portion 441. When seated on the valve seat 433, the sealing portion 432 closes the clearance between the large-diameter portion 441 and the valve element 416, from above. Between the sealing portion 432 and the strainer 9, there is disposed a conical spring 425 for urging the valve element 414 in the valve-closing direction.

The valve element 415 comprises a shaft part 419 in the form of a stepped cylinder which is axially guided by the small-diameter portion 435 of the guide member 410, and a low-pressure valve portion 320 which is inserted into and removed from a valve hole 323 (corresponding to “a second valve hole”) formed in a downstream portion of the body 404, for closing and opening the valve hole 323.

The shaft part 419 has a large-diameter portion 436 thereof slidably inserted into the small-diameter portion 435 of the guide member 410, and the outer peripheral edge of the upper end forms a valve seat portion 439 which is brought into and out of contact with the high-pressure valve portion 417. That is, the valve element 414 and the valve element 415 cooperatively open and close the valve hole 411.

Further, with such a construction, even if the valve hole 323 is closed by the valve element 415, refrigerant introduced from the port 8 slightly flows out via a gap formed between the low-pressure valve portion 320 and the valve hole 323 into the port 7 and is delivered into the suction chamber. Then, when the valve element 415 is open, refrigerant flows from the port 8 into the port 7 at a flow rate to be normally assumed when the valve is open.

### Fifth Embodiment

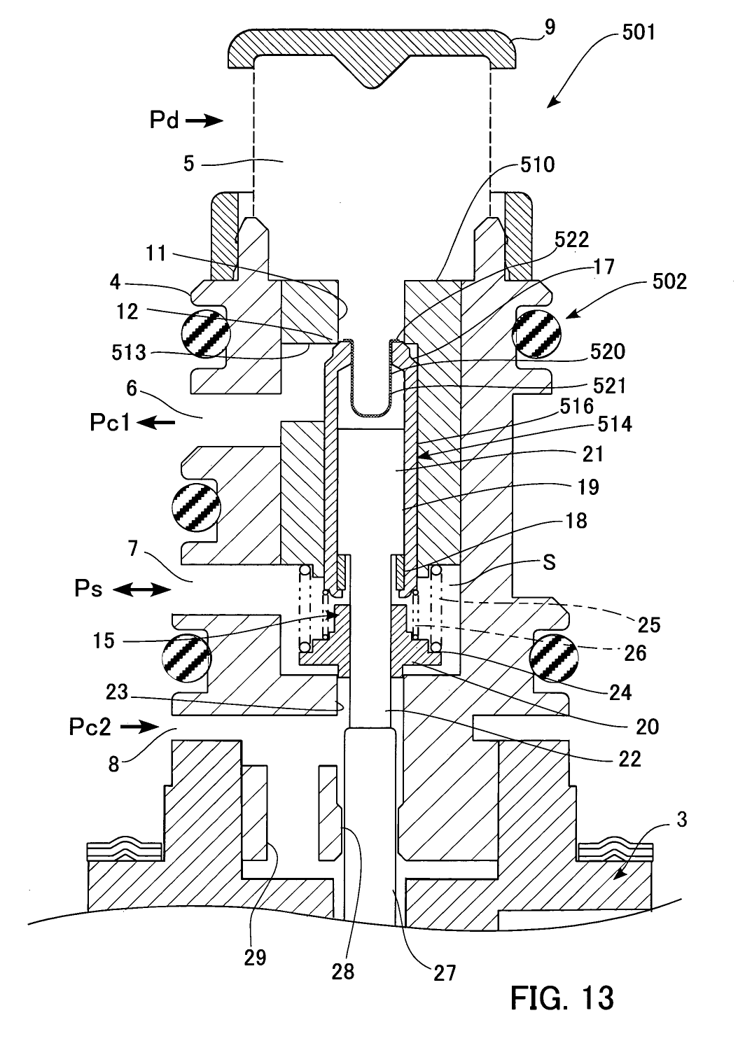

Next, a fifth embodiment of the present invention will be described. The control valve for a variable displacement compressor, according to the present embodiment, has substantially the same construction as that of the first embodiment except that a construction for preventing clogging with dirt is additionally provided. Therefore, component elements substantially identical to those of the first embodiment are designated by the same reference numerals, and description thereof is omitted as deemed appropriate. FIG. 13 is a cross-sectional view showing the construction of the control valve according to the present embodiment.

In the control valve 501 for a variable displacement compressor, the stepped portion of a guide member 510 fitted in the body 4 of a three-way valve 502 has a side thereof formed with a communication hole 513 larger than the communication hole 13 appearing in FIG. 2, for communication between the port 5 and the port 6.

Further, a valve element 514 that opens and closes the valve hole 11 is axially larger than the valve element 14 appearing in FIG. 2, and has a filter 520 in the form of a cup fitted in an opening at the foremost end of the high-pressure valve portion 17. The filter 520 has a main body 521 U-shaped in cross-section which extends toward the inside of the valve element 514, and a flange portion 522 formed at the periphery of an upper end thereof is joined to a foremost end of the high-pressure valve portion 17.

Thus, the filter 520 is provided in the vicinity of the high-pressure valve portion 17, for partitioning between the inside and the outside of the valve main body 16, which makes it possible to prevent or suppress dirt contained in the high-pressure refrigerant introduced into the port 5 from flowing into the inside of the valve element 514. As a result, it is possible to prevent occurrence of clogging of dirt or foreign matter between the main valve body 516 of the valve element 514 and the large-diameter portion 21 of the valve element 15, thereby maintaining smooth mutual sliding between the valve elements.

### Sixth Embodiment

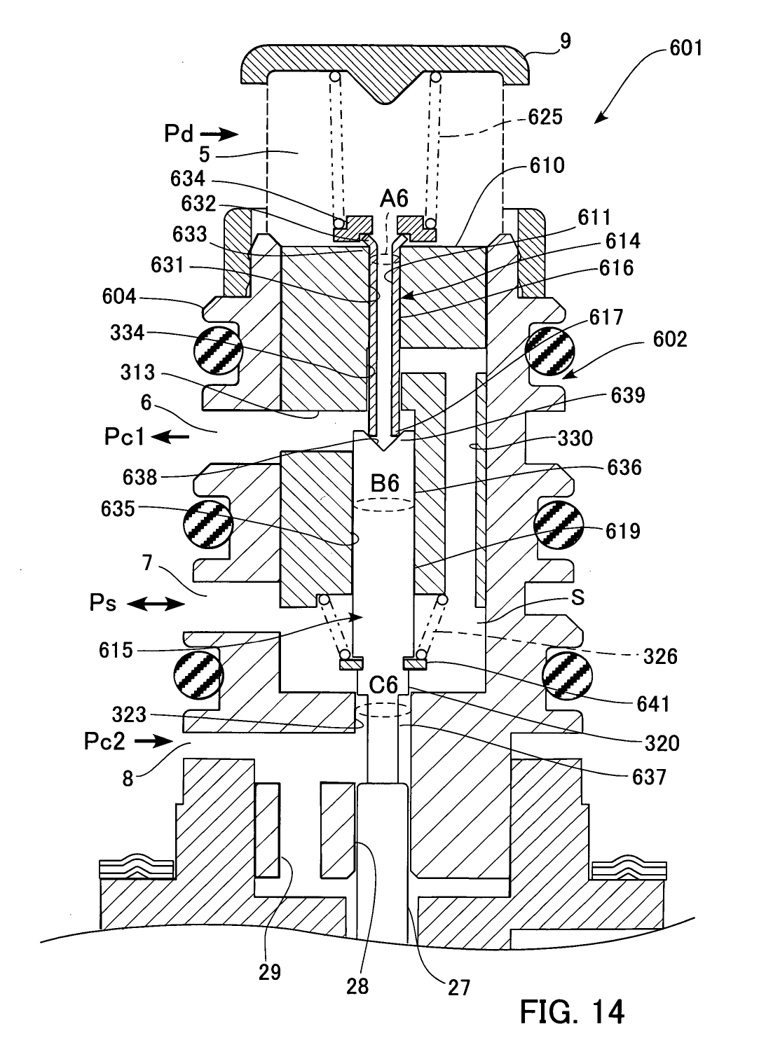

Next, a sixth embodiment of the present invention will be described. The control valve for a variable displacement compressor, according to the present embodiment, has substantially the same construction as that of the third embodiment except that the cross-section of each valve element is formed to be small for high-pressure refrigerant. Therefore, component elements substantially identical to those of the third embodiment are designated by the same reference numerals, and description thereof is omitted as deemed appropriate. FIG. 14 is a cross-sectional view showing the construction of the control valve according to the present embodiment.

In the control valve 601 for a variable displacement compressor, a guide member 610 in the form of a hollow cylinder is fitted in an upper end opening of a body 604 of a three-way valve 602. A small-diameter portion 631 of the guide member 610 has a valve element 614 (corresponding to “a first valve element”) axially slidably inserted therein, and the internal passage of the valve element 614 defines a valve hole 611 (corresponding to “a first valve hole”). Further, a large-diameter portion 635 of the guide member 610 has a long valve element 615 (corresponding to “a second valve element”) axially slidably disposed therein in opposed relation to the valve element 614.

The valve element 614 has a valve main body 616 in the form of a hollow cylinder inserted in a small-diameter portion 631 (corresponding to “a guide hole”) of the guide member 610, for being axially guided therein, and a downstream end of the valve element 614 forms a high-pressure valve portion 617. Further, an upstream end of the valve element 616 has its diameter increased in a tapered manner as it extends upward to form a sealing portion. The sealing portion 632 is configured such that it can be seated on and removed from a valve seat 633 formed by the rim of an opening at an upstream end of the small-diameter portion 631. When seated on the valve seat 633, the sealing portion 632 closes the clearance between the small-diameter portion 631 and the valve main body 616, from above. A spring receiver 634 is attached to the sealing portion 632, and between the sprig receiver 634 and the strainer 9, there is disposed a conical spring 625 for urging the vale element 614 in the valve-closing direction.

The valve element 615 comprises a shaft part 619 in the form of a stepped cylinder which is axially guided by the large-diameter portion 635 of the guide member 610, and a low-pressure valve portion 320 which is inserted into and removed from a valve hole 323 (corresponding to “a second valve hole”) formed in a downstream portion of the body 604, for closing and opening the valve hole 323.

The shaft part 619 comprises a large-diameter portion 636 that is slidably inserted into the large-diameter portion 635 of the guide member 610, and a small-diameter portion 637 partially inserted into the valve hole 323, and is disposed substantially on the same axis as that of the shaft 27. The large-diameter portion 636 has an upstream end thereof formed with a recess 638 having a tapered sloping surface which forms a valve seat portion 639 that is brought into and out of contact with the high-pressure valve portion 617. A spring receiver 641 is mounted between the large-diameter portion 636 and the low-pressure valve portion 320, and a conical spring 326 is interposed between the spring receiver 641 and a lower end face of the guide member 610, for urging the low-pressure valve portion 320 in a valve-closing direction.

In the control valve 601 for a variable displacement compressor as well, the cross-sectional area of the small-diameter portion 631 of the guide member 610 is represented by A6, that of the large-diameter portion 635 by B6, and that of the valve hole 323 by C6 (=B6−A6). Therefore, the crankcase pressures Pc (Pc1 and Pc2) applied to the combined body of the valve element 614 and the valve element 615 are cancelled out, whereby the valve element 614 moves in the valve-opening or valve-closing direction by purely sensing the differential pressure (Pd−Ps) between the discharge pressure Pd and the suction pressure Ps.

It should be noted that the control valve 601 constructed as described above operates substantially similarly to the control valve 301 according to the third embodiment, and hence detailed description of the operation is omitted.

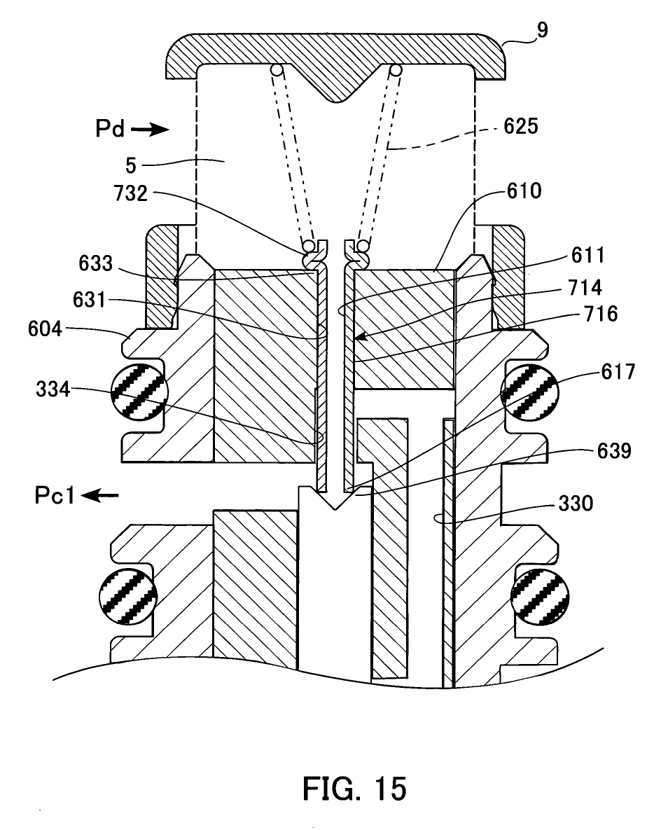

FIGS. 15 to 17 are respective explanatory views of variations of the sixth embodiment, which each illustrate a sealing portion and its vicinity of the first valve element, on enlarged scale.

That is, as shown in FIG. 15, an upstream end of a main valve body 716 of a valve element 714 (corresponding to “a first valve element”) may be swaged and axially folded to thereby form a sealing portion 732.

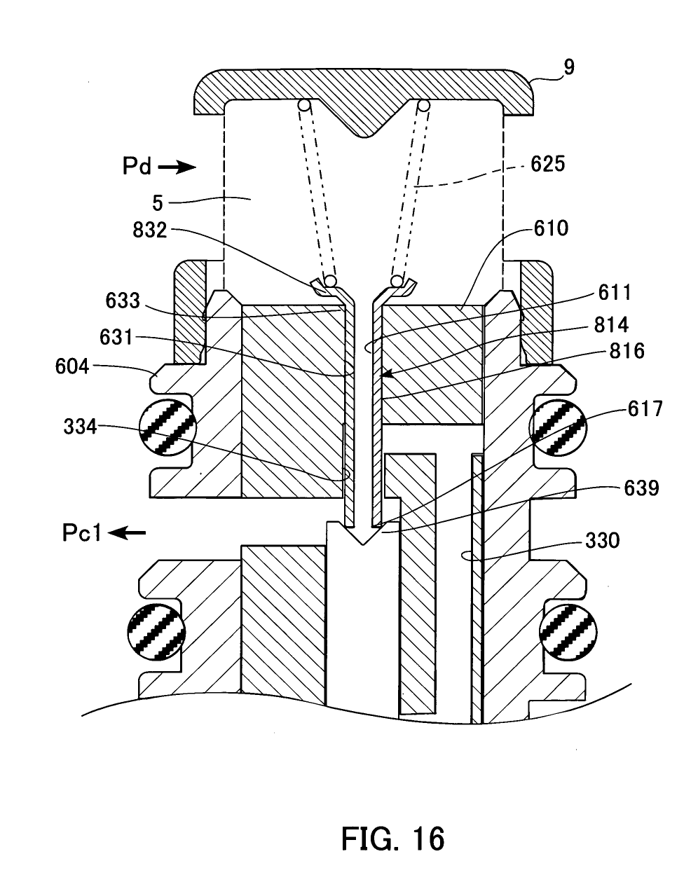

Alternatively, as shown in FIG. 16, an upper end of a valve main body 816 of a valve element 814 (corresponding to “a first valve element”) may be expanded outward to form a sealing portion 832, and one end of a spring 625 may be placed on the sealing portion 832.

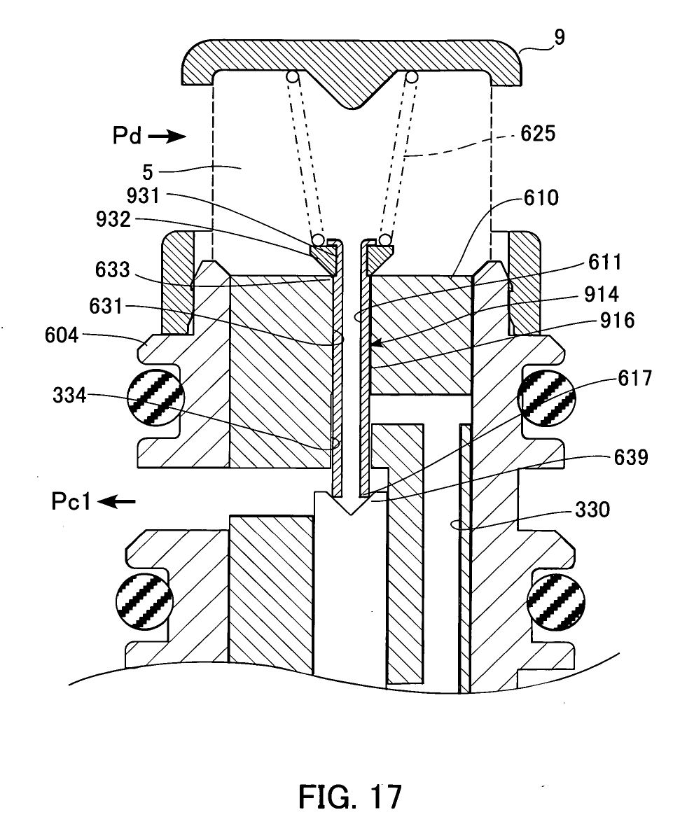

Further, as shown in FIG. 17, an upper end of a main valve body 916 of a valve element 914 (corresponding to “a first valve element”) may be formed as a thin portion 931, and after fitting a tapered sealing member 932 on the thin portion 931, the thin portion 931 may be swaged to fix the sealing member 932.

### Seventh Embodiment

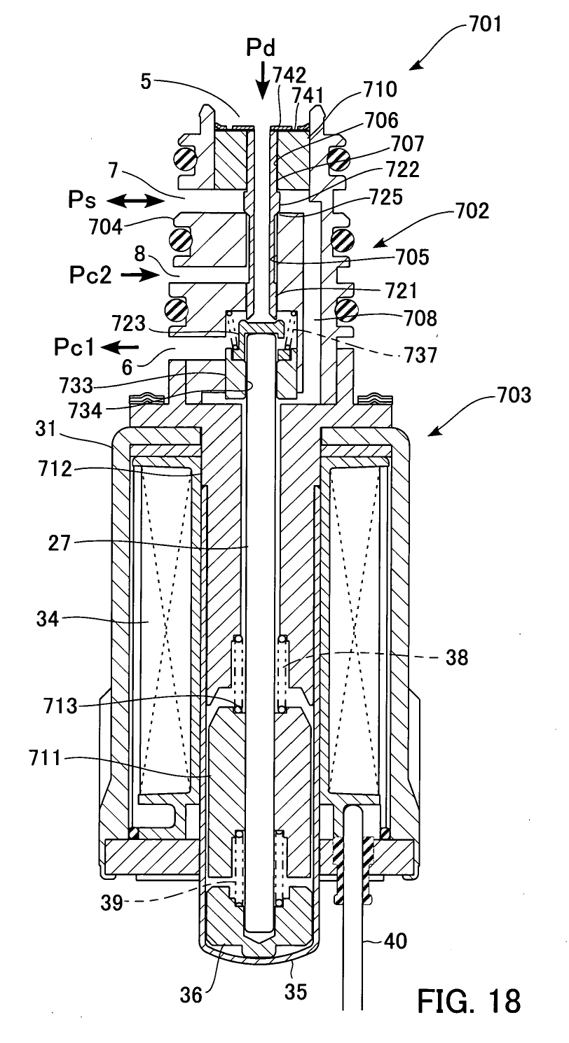

Next, a seventh embodiment of the present invention will be described. The control valve for a variable displacement compressor, according to the present embodiment, has substantially the same construction as that of the first embodiment except that the construction of the three-way valve is different. Therefore, component elements substantially identical to those of the first embodiment are designated by the same reference numerals, and description thereof is omitted as deemed appropriate. FIG. 18 is a cross-sectional view showing the construction of the control valve according to the present embodiment.

In the control valve 701 for a variable displacement compressor, a guide member 710 in the form of a hollow cylinder is fitted in an upper end opening of the body 704 of the three-way valve 702. The guide member 710 has an inner diameter equal to that of a through hole 705 axially extending through the body 704, and forms a guide hole 706 together with the through hole 705. The guide hole 706 has a valve element-forming member 707 in the form of a long hollow cylinder axially movably inserted therein.

Further, in a side of the body 704, sequentially from the port 5 side formed in an upper end of the body 704, there are formed a port 7 that receives suction pressure Ps, a port 8 that introduces the crankcase pressure Pc2, and a port 6 that deliverers crankcase pressure Pc1 (=Pc2), all of which communicate with the through hole 705. Further, the body 704 has a refrigerant passage 708 communicating between the inside of the solenoid 703 and the port 7, formed in parallel with the through hole 705. It should be noted in FIG. 18, a strainer covering the port 5 (see the strainer 9 in FIG. 1) is omitted.

Further, although the solenoid 703 is not formed with the spring-receiving member 37 appearing in FIG. 1, at an upper end of a plunger 711, the center of an end face of the solenoid is spot-faced to form a spring-receiving portion 713 for supporting a lower end of the spring 38. A core 712 has a lower end of the body 704 press-fitted in the opening at an upper end of the core 712, and the refrigerant passage 708 communicates with a passage between the core 712 and the shaft 27.

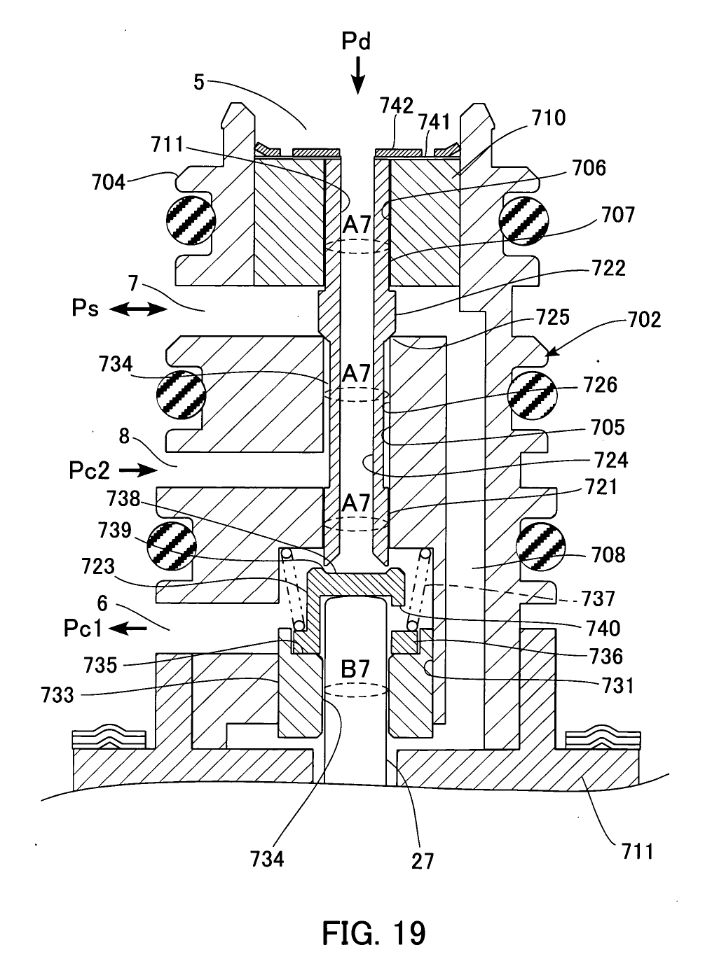

FIG. 19 is an enlarged view of the control valve for a variable displacement compressor.

The vale element-forming member 707 has a high-pressure valve portion 721 (corresponding to “a first valve element”) formed at a downstream end of a main body thereof in the form of a long hollow cylinder, and a low-pressure valve portion 722 (corresponding to “a second valve element”) formed at an intermediate portion thereof. That is, the high-pressure valve portion 721 and the low-pressure valve portion 722 are formed axially integrally with the valve element-forming member 707. The valve element-forming member 707 has the high-pressure valve portion 721 and an end opposite thereto disposed in the guide hole 706 (including the through hole 705) while sliding therealong.

The high-pressure valve portion 721 has an inner surface of a lower end thereof formed as a tapered surface the diameter of which increases as it extends downward. A foremost end of the high-pressure valve portion 721 is seated on and removed from a valve seat-forming member 723 (corresponding to “a valve seat-forming member”) supported by the shaft 27 from below. Then, the inner passage of the valve-forming member 707 forms a first valve hole 724, and the high-pressure valve portion 721 and the valve seat-forming member 723 form a “first valve” that opens and closes the first valve hole 724. On the other hand, the low-pressure valve portion 722 has a larger cross-section than that of the through hole 705, and has a lower end formed with a tapered surface the outer diameter of which decreases as it extends downward. The tapered surface is seated on and removed from the valve seat 725 formed by the outer peripheral edge of the opening at the upper end of the through hole 705. Further, a portion of the through hole 705, which communicates between the port 7 and the port 8, forms a second valve hole 726, and the low-pressure valve portion 722 and the valve seat 725 forms a “second valve” that opens and closes the second valve hole 726. A portion of the main body of the valve element-forming member 707 between the high-pressure valve portion 721 and the low-pressure valve portion 722 is reduced in diameter, to provide a predetermined clearance between the same and the through hole 705.

Further, the body 704 has a lower end thereof formed with a hole 731 that opens downward. The hole 731 has a larger cross-section than that of the through hole 705, with an upper end of the hole 731 communicating with the through hole 705, and a lateral portion thereof communicating with the port 6. The hole 731 has a hollow cylindrical bearing member 733 press-fitted in a lower end thereof. The bearing member 733 has the shaft 27 slidably inserted in the through hole 734 thereof, for supporting the shaft 27. The bearing member 733 has an upper end face thereof formed with a recess 735 for supporting the lower end of the valve seat-forming member 723 in a manner accommodating the same therein.

The valve seat-forming member 723 in the form of a bottomed hollow cylinder in which an upper end of the shaft 27 can be inserted, and has an inner diameter larger than the outer diameter of the shaft 27. The valve seat-forming member 723 has a lower end thereof circumferentially formed with a flange portion 73 extending outward. Between the flange portion 736 and the body 704, a conical spring 737 is interposed for urging the valve seat-forming member 723 against the shaft 27. Further, the valve seat-forming member 723 has an upper end face formed with a recess 738 having a tapered surface along the peripheral edge thereof, thereby forming a valve seat 739 for having a foremost end of the high-pressure valve portion 721 seated on and removed from the valve seat 739. Further, the valve seat-forming member 723 has a side formed with a communication hole 740 for communicating between the inside and outside of the valve seat-forming member 723.

Here, the cross-sectional area A7 of the guide hole 706 (including the through hole 705) is equal to the cross-sectional area B7 of the thorough hole 734 of the bearing member 733. Therefore, the crankcase pressures Pc (Pc1 and Pc2) applied to the combined body of the valve element-forming member 707, the valve seat-forming member 723, and the shaft 27 are cancelled out, so that the valve element-forming member 707 moves in a valve-opening or valve-closing direction by purely sensing the differential pressure (Pd−Ps) between the discharge pressure Pd and the suction pressure Ps.

Further, the guide member 710 and the valve element-forming member 707 have a circular sealing member 741 of flexible polyimide film mounted on upper end faces thereof such that the sealing member 741 seals the clearance between the valve element-forming member 707 and the guide hole 706. In the center of the sealing member 741, there is formed a circular hole having the same cross-section as that of the first valve hole 724. Then, a leaf spring 742 (corresponding to “urging means”) is fitted on an opposite side of the sealing member 741 to the valve element-forming member 707, for urging the sealing member 741 into close contact with the valve element-forming member 707.

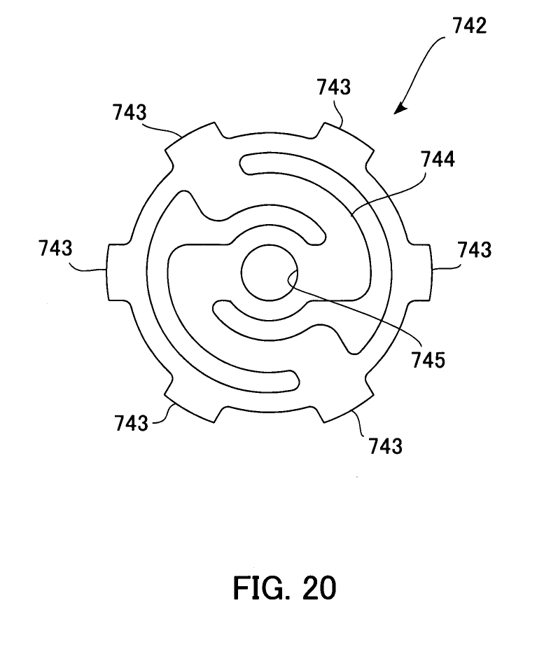

FIG. 20 is a plan view showing the construction of the leaf spring.

The leaf spring 742 has an annular main body that has six legs 743 formed along a periphery thereof at circumferentially equally spaced intervals (of 60 degrees) in a radially outwardly protruding manner. Further, inward of the body, an S-shaped spring portion 744 is formed continuously, and has a circular hole 745 having the same cross-section as that of the first valve hole 724 formed in the center thereof. As shown in FIG. 19, the leaf spring 742 is fitted in the opening at the upper end of the body 704, in a manner bent upward, and the spring 744 urges the sealing member 741 into close contact with an interface between the valve element-forming member 707 and the guide member 710.

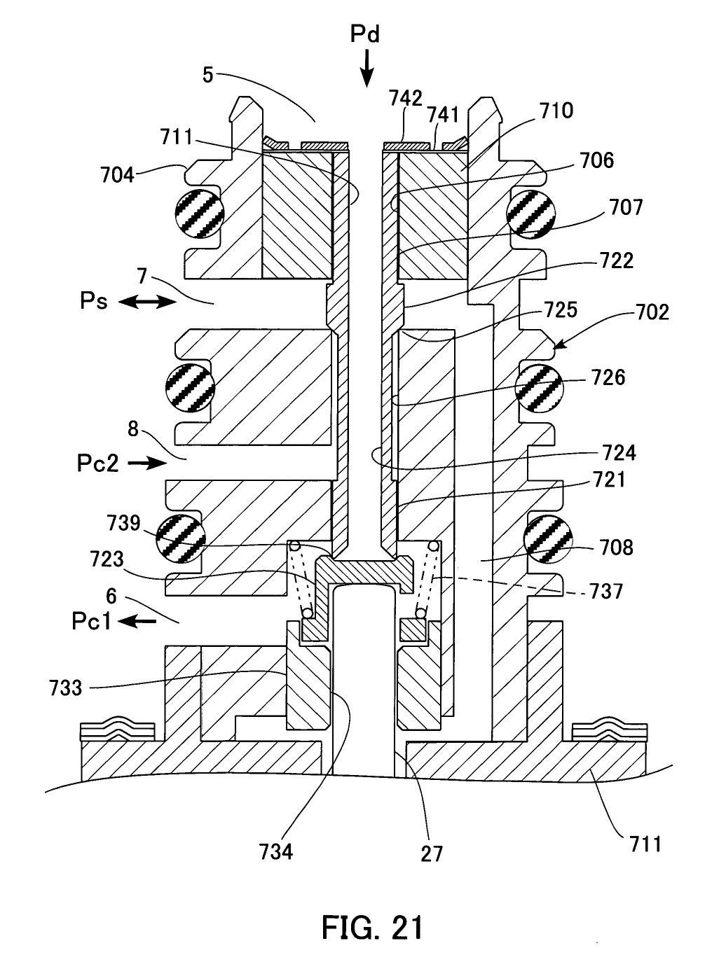

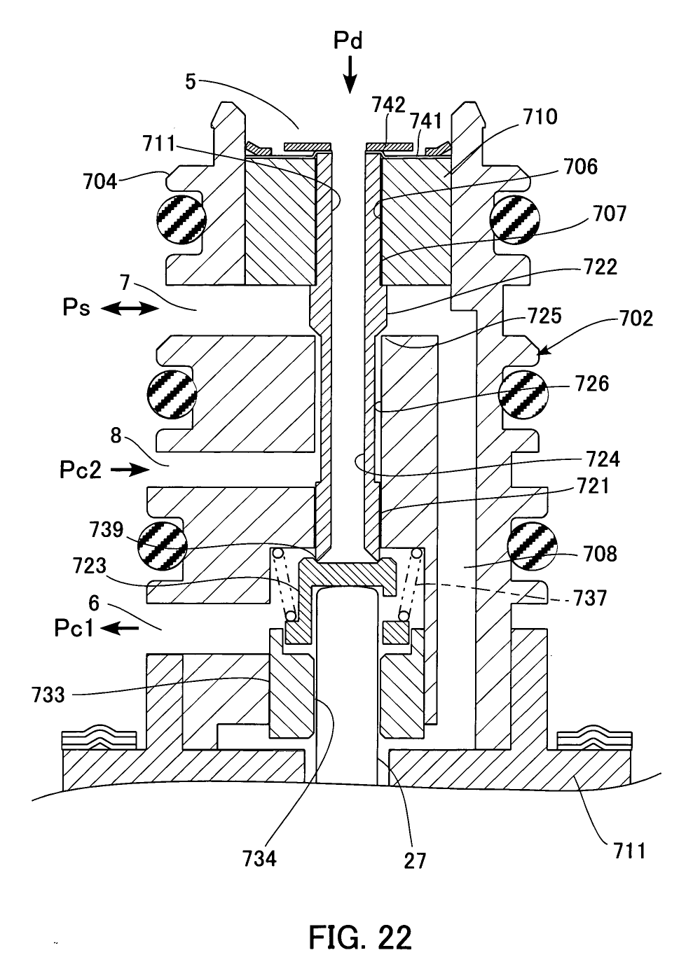

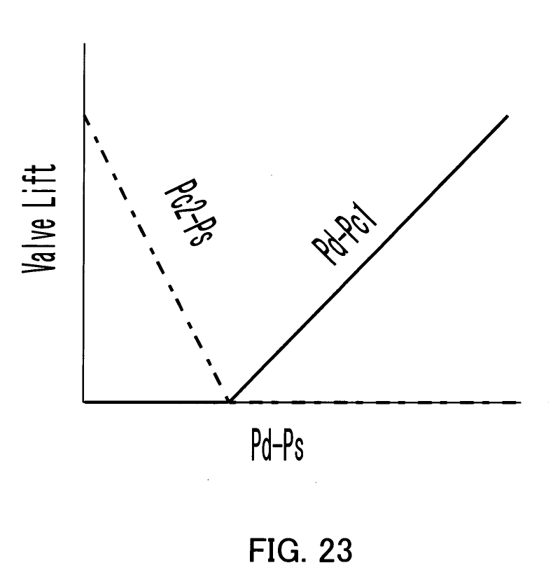

Next, a description will be given of the operation of the control valve 701 for a variable displacement compressor 701 with reference to FIGS. 19, and 21 to 23. FIGS. 21 and 22 are cross-sectional views illustrating the operation of the control valve. FIG. 23 is a graph showing the relationship between valve opening degrees of the first valve and the second valve with respect to the differential pressure (Pd−Ps) between the discharge pressure Pd and the suction pressure Ps. In this figure, the horizontal axis represents the magnitude of the differential pressure (Pd−Ps), and the vertical axis represents the amount of valve lift of the Pd-Pc1 valve (first valve) and the Pc2-Ps valve (second valve). In the figure, a solid line represents characteristics of the Pd-Pc1 valve, while a one-dot-chain line represents characteristics of the Pc2-Ps valve.

When the solenoid 703 is not energized, as shown in FIG. 19, the urging force of the conical spring 737 causes the high-pressure valve portion 721 to separate from the valve seat 739 (i.e. the valve element-forming member 707 is away from the valve set-forming member 723), whereby the high-pressure Pd-Pc1 valve is fully open. On the other hand, the urging force of the spring valve 742 causes the low-pressure valve portion 722 to be seated on the valve seat 725, whereby the low-pressure Pc2-Ps valve is fully closed.

At this time, when the discharge pressure Pd is introduced from the discharge chamber of the compressor, the discharge pressure Pd is introduced into the crankcase via the Pd-Pc1 valve while being changed into crankcase pressure Pc1 (=Pc2). Since the refrigerant passage extending from the crankcase to the suction chamber is closed by the Pc2-Ps valve, so that the crankcase pressure Pc1 becomes close to the discharge pressure Pd, which minimizes the differential pressure between pressures applied to the opposite ends of each piston of the compressor, whereby the wobble plate assumes an inclination angle which minimizes the stroke of the piston. This controls the compressor to the minimum displacement operation.

It should be noted that the clearance between the valve element-forming member 707 and the guide member 710 is seated by the sealing member 741 from above, so that dirt or foreign matter is prevented from flowing into the clearance (i.e. the guide hole 706).

Here, if the electric current supplied to the solenoid 703 is increased, the plunger 711 is attracted upward by the plunger 711 to move upward (see FIG. 18). Then, as shown in FIG. 21, the valve seat-forming member 723 moves upward together with the shaft 27, which causes the high-pressure valve portion 721 to be seated on the valve seat 739, thereby closing the Pd-Pc1 valve. At this time, the valve element-forming member 723 is slightly floated from the bearing member 733. Then, from this state, as the valve seat-forming member 723 moves further upward together with the valve element-forming 707, the Pc2-Ps valve starts to open. At this time, the crankcase pressure Pc2 is delivered into the suction chamber via the second valve hole 726, so that the crankcase pressure Pc1 progressively becomes small. As a result, the compressor is controlled to an operation with displacement corresponding to the value of electric current supplied to the solenoid 703.

When a predetermined electric current is supplied to the solenoid 703, the Pd-Pc1 valve and the pc2-Ps valve are controlled to respective valve opening degrees corresponding to the value of electric current. At this time, when the engine speed, i.e. the rotational speed of the compressor has changed to change the differential pressure between the discharge pressure Pd and the suction pressure Ps, the control valve 701 performs control such that the change in the differential pressure changes the stroke of the Pd-Pc1 valve or that of the Pc2-Ps valve to vary the displacement of the compressor, whereby the differential pressure between the discharge pressure Pd and the suction pressure Ps is maintained at a predetermined differential pressure set by the solenoid current.

Further, particularly when the automotive air conditioner is started or when the cooling load is maximum, the value of electric current supplied to the solenoid 703 becomes maximum. At this time, the plunger 711 is attracted by the core 712 with the maximum attractive force, so that as shown in FIG. 22, the valve element-forming member 707 is displaced to the top dead center position, in unison with the valve seat-forming member 723 and the shaft 27, whereby the low-pressure valve portion 722 is made the most distant from the valve seat 725 to fully open the Pc2-Ps valve. It should be that the top dead center position corresponds to a position in which the end face of the low-pressure valve portion 722 opposite to the valve seat 725 is in contact with the lower end face of the guide member 710. At this time, the high-pressure refrigerant at the discharge pressure Pd introduced into the port 5 is prevented from being delivered into the port 6, which makes the crankcase pressure Pc close to the suction pressure Ps, whereby the compressor performs the maximum displacement operation.

It should be noted as shown in FIG. 22, even when the valve element-forming member 707 is displaced to protrude upward of the guide member 710, the sealing member 741 is in close contact with the valve element-forming member 707 by the urging force of the leaf spring 742, which prevents dirt or foreign matter from flowing into the guide hole 706.

The above-described operations of the Pd-Pc1 valve and the Pc2-Ps valve are as shown in FIG. 23. That is, the Pd-Pc1 valve and the Pc2-Ps valve do not open simultaneously, but after one of them is closed, the other opens.

As described hereinabove, in the control valve 701 for a variable displacement compressor, according to the present embodiment, after the first valve on the high-pressure side opens the first valve hole 724, the second valve on the low-pressure side opens the second valve hole 726. Therefore, it is possible to eliminate a region in which both the valves on the high-pressure and low-pressure sides are open simultaneously. This makes it possible to prevent refrigerant introduced into the crankcase from being immediately delivered, which makes it possible to obtain a sufficient compression efficient.

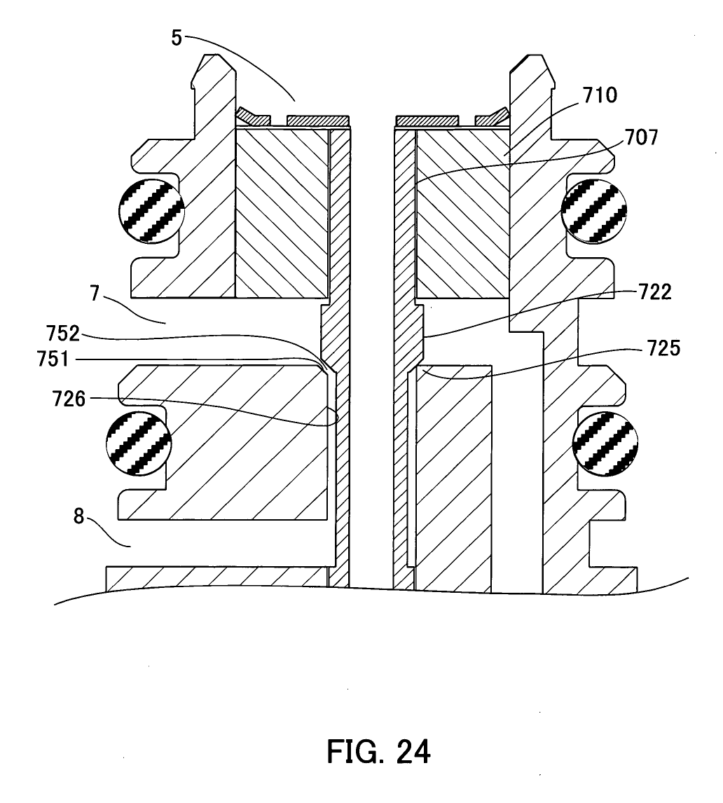

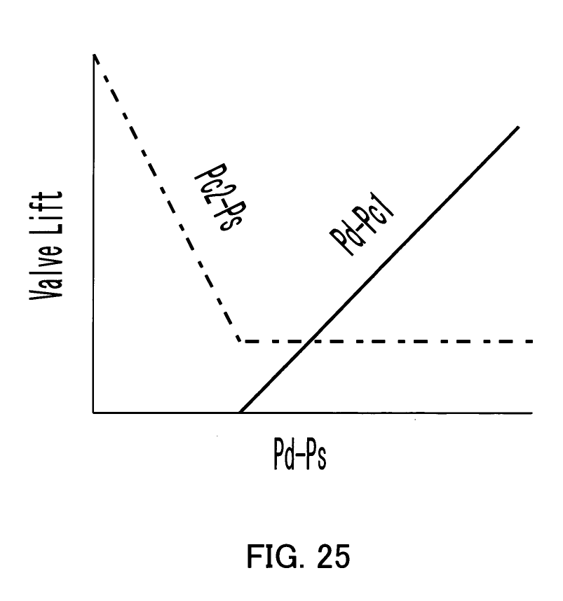

FIGS. 24 and 25 are explanatory views showing a first variation of the seventh embodiment.

More specifically, as shown in FIG. 24, part of the valve seat 725 on which the low-pressure valve portion 722 is seated may be formed with a cutout 751, thereby forming a refrigerant leakage passage 752 permitting the flow of refrigerant at a predetermined flow rate via the second valve hole 726 even when the second valve is closed.

With this construction, as shown in FIG. 25, even when the Pc2-Ps valve is fully closed, it is possible to obtain characteristics in which refrigerant is allowed to flow from the crankcase into the suction chamber via the refrigerant leakage passage 752 at a predetermined minimum flow rate (refrigerant at a slight flow rate) set in advance.

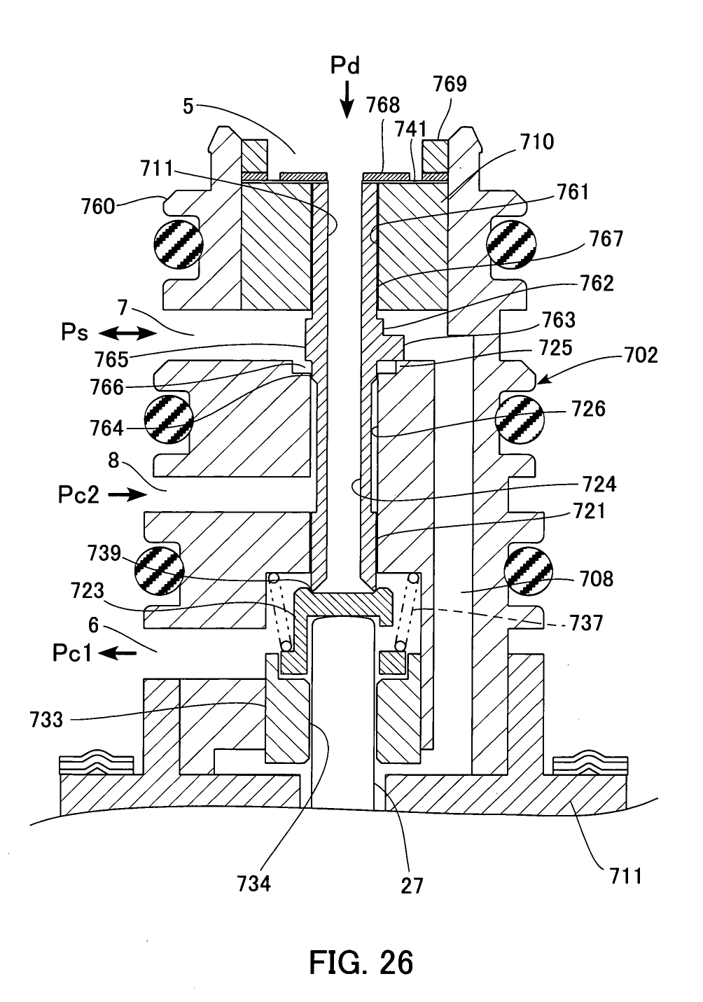

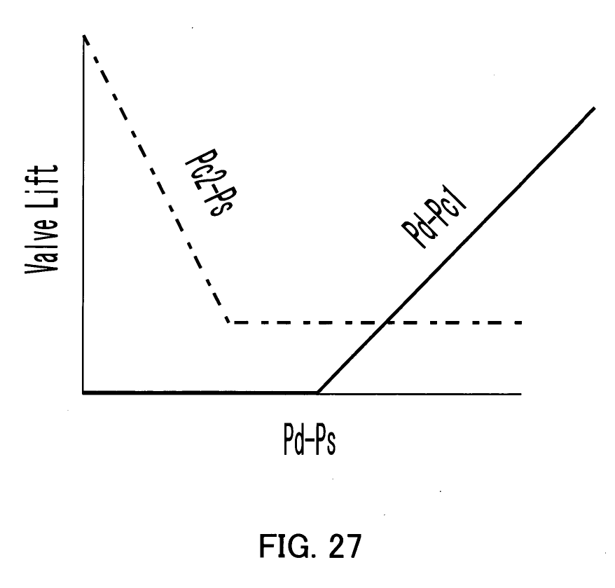

FIGS. 26 and 27 are explanatory views of a second variation of the seventh embodiment.

More specifically, as shown in FIG. 26, the low-pressure valve portion 762 of the valve element-forming member 761 may be formed as a spool valve which is inserted into and removed from the second valve hole 726.

An open end of the second valve hole 726 of the body 760 is spot-faced, and the foremost end of the low-pressure valve portion 762 is inserted into and removed from the second valve hole 726. Further, the outer periphery of the low-pressure valve portion 762 is formed with a flange portion 763 that extends radially outward, which is stopped by the open end (surface outward of the spot-faced portion) of the second valve hole 726. Between the foremost end of the low-pressure valve portion 762 and the second valve hole 726, a predetermined clearance 764 is formed, and part of the flange 763 is formed with a cutout 765. Therefore, even when the second valve is closed, a refrigerant leakage passage 766 is formed which permits refrigerant to flow at a predetermined flow rate via the clearance 764 and the cutout 765.

Further, a leaf spring 768 for urging the sealing member 741 and the valve element-forming member 767 from outside is not formed with legs 743 as in the case of the leaf spring 742 shown in FIG. 20, and hence the outer peripheral edge thereof is not bent differently from the case shown in FIG. 19. Instead, to prevent the leaf spring 768 from falling off, the open end of the body 760 has a retainer ring 769 press-fitted therein, for retaining the leaf spring 768 together with the sealing member 741 from outside.

With this construction, as shown in FIG. 27, even when the Pc2-Ps valve is fully closed, it is possible to obtain characteristics in which refrigerant is allowed to flow from the crankcase into the suction chamber via the refrigerant leakage passage 766 at a predetermined flow rate (refrigerant at a slight flow rate) set in advance. Further, it is possible to obtain characteristics in which a predetermined time period after the Pd-Pc1 valve is closed, the Pc2-Ps valve is proportionally opened.

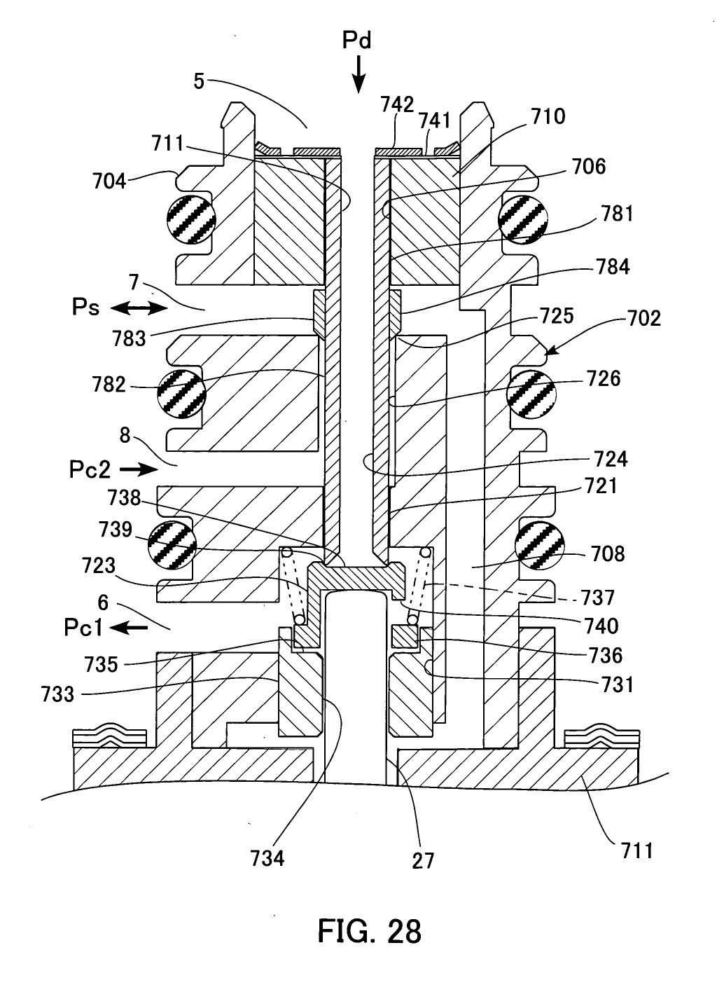

FIG. 28 is an explanatory view of a third variation of the seventh embodiment.

More specifically, a valve element-forming member 781 may be comprised of a valve main body 782 in the form of a long hollow cylinder having substantially the same cross-section over the entire length, and a low-pressure valve-forming member 783 in the form of a hollow cylinder 783 fitted on an intermediate portion of the main valve body 782. In this case, a foremost end of the valve main body 782 forms the high-pressure valve portion 721, and the low-pressure valve-forming member 783 forms a low-pressure valve portion 784.

When considering the case in which the valve element-forming member 707 appearing in FIG. 19 is formed by cutting, the valve element-forming member 781 is easy to machine, and hence can be obtained at a low cost.

### Eighth Embodiment

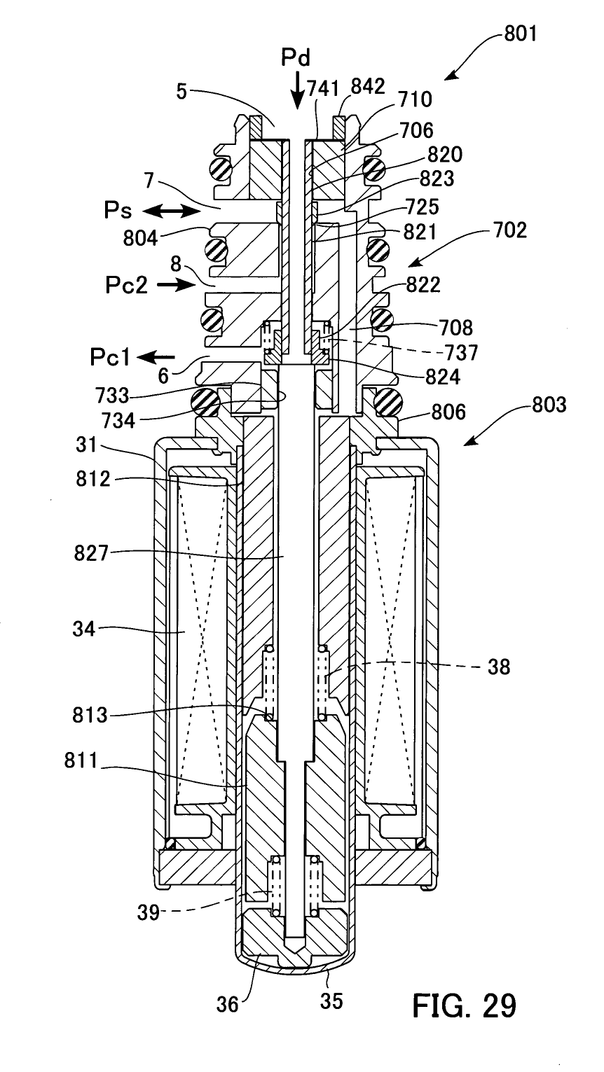

Next, an eighth embodiment of the present invention will be described. The control valve for a variable displacement compressor, according to the present embodiment, has substantially the same construction as that of the first embodiment except that the construction of the three-way valve is different, etc. Therefore, component elements substantially identical to those of the seventh embodiment are designated by the same reference numerals, and description thereof is omitted as deemed appropriate. FIG. 29 is a cross-sectional view showing the construction of the control valve according to the present embodiment.

In the control valve 801 for a variable displacement compressor, an annular connecting member 806 is provided between a body 804 formed with ports and a solenoid 803, for connecting these. A lower end of the body 804 is press-fitted in the connecting member 806, and an upper end of the case 31 of the solenoid 803 is swaged and joined onto the connecting member 806. Further, an upper end of a core 812 is press-fitted into an inner peripheral surface of the connecting member 806.

Further, an upper end face of a shaft 827 having a plunger 811 press-fitted thereon forms a valve seat of the first valve. It should be noted that in the present embodiment, the upper end face of the shaft 827 corresponds to the “a valve seat-forming member”.

More specifically, the valve element-forming member 820 comprises a valve main body 821 in the form of a long hollow cylinder having substantially the same cross-section over its entire length, a high-pressure valve-forming member 822 in the form of a stepped hollow cylinder press-fitted into a lower end of the valve main body 821, and a low-pressure valve-forming member 823 in the form of a hollow cylinder which is fitted on an intermediate portion of the main valve body 821 to have same inserted therein. Then, a lower end face of the high-pressure valve-forming member 822 is moved to and away from an upper end face of the shaft 827, to thereby open and close the second valve. In this case, the high-pressure valve-forming member 822 forms the high-pressure valve portion, while the low-pressure valve-forming member 823 forms the low-pressure valve portion. The lower end of the high-pressure valve-forming member 822 is formed with a flange portion 824 that extends radially outward, and a coil spring 737 is interposed between the flange portion 824 and the body 804, for urging the high-pressure valve-forming member 822 in a valve-closing direction (i.e. toward the shaft 827). With this construction, the valve seat-forming member 723 appearing in FIG. 19 can be omitted.

Further, the sealing member 741 is mounted on the upper surfaces of the guide member 710 and the valve element-forming member 820, and a retainer ring 842 is press-fitted on a side of the sealing member 741 opposite to the valve element-forming member 820, for fixing the sealing member 741 to the guide member 710.

Although it should be noted that in the above-described embodiments, the control valve for a variable displacement compressor is configured as a control valve that senses a differential pressure between discharge pressure Pd and suction pressure Ps, and controls the opening degrees of the associated valves such that the differential pressure is constant, by way of example, this is not limitative, but the same may be configured as a control valve that senses a differential pressure between discharge pressure Pd and crankcase pressure Pc, and controls the opening degrees of the associated valves such that the differential pressure is constant.

According to the control valve of the present invention for a variable displacement compressor, after the first valve element on the high-pressure side opens the first valve hole, the second valve element on the low-pressure side opens the second valve hole. Therefore, it is possible to eliminate a region in which both the valves on the high-pressure and low-pressure sides are open simultaneously. This makes it possible to prevent refrigerant introduced into the crankcase from being immediately delivered, which makes it possible to obtain a sufficient compression efficient.

The foregoing is considered as illustrative only of the principles of the present invention. Further, since numerous modifications and changes will readily occur to those skilled in the art, it is not desired to limit the invention to the exact construction and applications shown and described, and accordingly, all suitable modifications and equivalents may be regarded as falling within the scope of the invention in the appended claims and their equivalents.

What is claimed is:

1. A control valve for a variable displacement compressor, which controls refrigerant displacement of the compressor by sensing a differential pressure between discharge pressure in a discharge chamber and suction pressure in a suction chamber or a differential pressure between the discharge pressure and crankcase pressure in a crankcase, comprising:
a first valve element that is fitted to and removed from a first valve hole communicating between the discharge chamber and the crankcase to thereby close and open the first valve hole;
a second valve element that is fitted to and removed from a second valve hole communicating between the crankcase and the suction chamber to thereby close and open the second valve hole; and
a solenoid that is capable of applying a force in a valve-opening direction to said second valve element via a shaft, thereby making it possible to cause said first valve element and said second valve element to move either independently of or in unison with each other,
wherein after said first valve element closes the first valve hole, said second valve element opens the second valve hole.

2. The control valve according to claim 1, wherein said second valve element comprises:
a shaft portion that is disposed on a same axis as that of said shaft, and has a part thereof inserted into said second valve hole; and
a low-pressure valve portion that is formed on a periphery of said shaft portion, and has a part thereof inserted into or removed from the second valve hole, with a predetermined clearance therebetween, to thereby attain a closed or open state of the second valve hole, and
wherein said first valve element comprises:
a hollow cylindrical valve main body that has said shaft portion inserted therein, for being axially guided, and is disposed in axially opposed relation to said low-pressure valve portion, such that said valve main body is urged toward the first valve hole by urging means disposed between said valve main body and said low-pressure valve portion; and
a high-pressure valve portion that is formed continuous with said valve main body, and is fitted to or removed from the first valve hole to thereby attain a closed or open state of the first valve hole.

3. The control valve according to claim 2, wherein said second valve element is urged by other urging means in a valve-closing direction, and
wherein said first valve element is provided with a stopper portion that is engaged with said shaft portion at least when said second valve element is closed, for moving in unison with said second valve element, to move in a valve-opening direction.

4. The control valve according to claim 2, wherein a cross-sectional area of the second valve hole is set to a size obtained by subtracting a cross-sectional area of the first valve hole from a cross-sectional area of a guide hole within said body into which said valve main body of said first valve element is inserted.

5. The control valve according to claim 2, wherein an opposite end of said valve main body to said high-pressure valve portion is disposed in a refrigerant space communicating with the suction chamber.

6. The control valve according to claim 5, wherein when said second valve element is opened, an opposite end of said low-pressure valve portion to an end thereof which is fitted to or removed from the second valve hole is stopped by an opposite end of said main valve body to said high-pressure valve portion, whereby an amount of lift of said low-pressure valve portion from the second valve hole to be assumed when said low-pressure valve portion is fully opened is restricted.

7. The control valve according to claim 5, wherein an opposite end of said first valve element to said high-pressure valve portion is formed with an opening which opens into the refrigerant space.

8. The control valve according to claim 3, wherein said main valve body of said first valve element has said stopper portion formed at an increased-diameter portion that is formed on an opposite end of said main valve body to said high-pressure valve portion, and a portion of said main valve body toward said high-pressure valve portion with respect to said increased-diameter portion is axially guided by a guide hole formed within a body.

9. The control valve according to claim 1, wherein said first valve element comprises:
a hollow cylindrical valve main body that is inserted into a guide hole formed within a body in a manner axially movable therealong, and at the same time has the first valve hole defined therein;
a high-pressure valve portion that is provided on a downstream side of said valve main body, for opening and closing the first valve hole in cooperation with said second valve element; and
a sealing portion formed in continuous relation to an upstream side of said valve main body and configured such that said sealing portion can be fitted to and removed from an upstream end of the guide hole, said sealing portion being urged by urging means in a seating direction toward the guide hole, and
wherein said second valve element comprises:
a shaft portion that is disposed substantially on a same axis as that of said shaft, and has a part thereof inserted into the second valve hole;
a low-pressure valve portion that is formed on a periphery of said shaft portion, and has a part thereof inserted into the second valve hole, with a predetermined clearance therebetween, to thereby attain a closed or open state of the second valve hole; and
a valve seat portion that is provided on an opposite side of said shaft portion to said shaft, for being brought into and out of contact with said high-pressure valve portion.

10. The control valve according to claim 9, wherein said sealing portion is formed continuously such that said sealing portion has its diameter increased in a tapered manner as said sealing portion extends toward an upstream side.

11. The control valve according to claim 9, further comprising:
an increased-valve portion that is provided in the guide hole on a downstream side with respect to a portion of the guide hole to and from which said sealing portion is fitted and removed; and
a communication hole that is formed within said body, for communicating between said increased-diameter portion and a refrigerant space communicating with the suction chamber.

12. The control valve according to claim 2, wherein a filter is provided close to said high-pressure valve portion of said first valve element, for partitioning between inside and outside of said valve main body.

13. A control valve for a variable displacement compressor, which controls refrigerant displacement of the compressor by sensing a differential pressure between discharge pressure in a discharge chamber and suction pressure in a suction chamber or a differential pressure between the discharge pressure and crankcase pressure in a crankcase, comprising:
a first valve that opens and closes a first valve hole communicating between the discharge chamber and the crankcase;
a second valve that opens and closes a second valve hole communicating between the crankcase and the suction chamber; and
a solenoid that is capable of directly or indirectly applying a force in a valve-opening direction or a valve-closing direction to said first valve and said second valve via a shaft,
wherein after said first valve closes the first valve hole, said second valve opens the second valve hole.

14. The control valve according to claim 13, wherein said solenoid is capable of applying a force in the valve-opening direction to a second valve element as a component of said second valve via said shaft, thereby making it possible to cause said first valve and said second valve to move either independently of or in unison with each other.

15. The control valve according to claim 13, comprising:
a hollow cylindrical valve element-forming member that is formed axially integrally with a first valve element as a component of said first valve and a second valve element as a component of said second valve, with the first valve hole defined therein, and is supported in a guide hole formed in a body, in a manner axially movable therealong;
a valve seat-forming member that is provided between said valve element-forming member and said shaft, for moving in unison with said shaft; and
a valve seat that is formed in an opening of an end of the second valve hole formed in the body,
wherein said first valve element is formed at a foremost end of said valve element-forming member, for being seated on and removed from said valve seat-forming member, and said second valve element is formed on an intermediate portion of said valve element-forming member, for being seated on and removed from said valve seat.

16. The control valve according to claim 15, wherein an opposite end of said valve element-forming member to said first valve element is slidably inserted into the guide hole, and
wherein a flexible sealing member is disposed for sealing a clearance between said valve element-forming member and the guide hole, from outside.

17. The control valve according to claim 16, comprising urging means for urging said sealing member from a side opposite to said valve element-forming member such that said sealing member is brought into close contact with said valve element-forming member.

18. The control valve according to claim 17, wherein said urging means comprises a leaf spring having an periphery thereof fixed to said body.

19. The control valve according to claim 15, wherein a refrigerant leakage passage is formed between said second valve element and said valve seat, so as to allow refrigerant to flow at a predetermined flow rate via the second valve hole even when said second valve is closed.

20. The control valve according to claim 19, wherein the refrigerant leakage passage is formed by a cutout provided in at least one of said second valve element and said valve seat.

21. The control valve according to claim 15, wherein said second valve element comprises a spool valve that has a part thereof inserted into and removed from the second valve hole with a predetermined clearance therebetween, and limits a flow rate of refrigerant at least in an initial stage of opening of said second valve.

22. The control valve according to claim 15, wherein the guide hole, the second valve hole, and a hole into which said shaft is inserted, which are formed in said body, have a same cross-sectional area, whereby forces applied to said valve element-forming member by the crankcase pressure are cancelled out.
